(19) United States
(12) Patent Application Publication
(10) Pub. No.: US 2025/0212902 A1
(43) Pub. Date: Jul. 3, 2025

(54) METHOD AND COMPOSITION FOR IMPROVEMENT OF AGRICULTURAL PRODUCE

(71) Applicants: UPL CORPORATION LIMITED, Port Louis (MU); UPL EUROPE LTD., Warrington (GB)

(72) Inventors: Luciano KAJIHARA, Campinas (BR); Ayrton NETO, Campinas (BR); Flavia MEGDA, Campinas (BR)

(21) Appl. No.: 18/844,131

(22) PCT Filed: Mar. 7, 2023
(86) PCT No.: PCT/IB2023/052115

§ 371 Date: Sep. 5, 2024

(30) Foreign Application Priority Data
Mar. 8, 2022 (IN) 202211012452

(51) Int. Cl. A23B 7/154; A01N 3/00; A01N 3/02; A23B 2/762; A23B 2/767; A23B 2/771; A23B 2/779

(52) U.S. Cl. CPC A23B 7/154; A01N 3/00; A01N 3/02; A23B 2/762; A23B 2/767; A23B 2/771; A23B 2/779

(57) ABSTRACT

The present invention relates to a method for improving yield, disease management and post-harvest quality of a crop, a plant or an agricultural produce using laminarin or a composition comprising laminarin. The present invention also relates to combinations of laminarin and additional agrochemically active agents, such as fungicides for improving yield, disease management and post-harvest quality of a crop, a plant or an agricultural produce.

### FIELD OF THE INVENTION

The present invention relates to a method for improving yield, disease management and post-harvest quality of a crop, a plant, or an agricultural produce. The present invention also relates to a composition and use of the same. The present invention also relates to combinations and their use for improving yield, disease management and post-harvest quality of a crop, a plant or an agricultural produce.

### BACKGROUND OF THE INVENTION

During the life cycle of a crop, it is prone to attack by pests and environmental changes which can lead to disease and low yields. The ever-increasing demand for raising food production translates into requirement for better disease management and yield of the crop. Further, when a crop is harvested and separated from its parent plant, it begins to deteriorate. It is prone to degradation and rot by fungal pests, biochemical, enzymatic, or physical factors. Various measures and techniques are applied to preserve the produce for a longer time as it passes through multiple stages post-harvest. It becomes imminent to maintain the freshness, vigor and quality of the produce for extended periods of time till the produce reaches the consumers. Therefore, steps ought to be taken at every stage of the agriculture cycle to ensure post-harvest quality of agricultural produce is maintained.

Post-harvest management ensures the preservation of agricultural produce in terms of its safety, quality and quantity.

Laminarin is a naturally occurring polysaccharide derived from seaweed, a polymer of simple sugars linked together by glycosidic bonds. Brown algae may contain up to 35% laminarin on a dry weight basis, depending on 44 species, season, habitat and extraction method. More specifically, it is a class of storage β-glucans comprised of β-(1-3)-linked glucose residues with some β-(1-6)-intrachain linkages, and some 6-O-branching in the main chain. D-mannitol occurs at 2-3% of reducing termini and these chains are referred to as M chains, while those with glucose at the reducing termini are known as G chains. The exact molecular structure of laminarin varies depending on environmental factors such as water temperature, salinity and nutrient salts, waves, sea current and immersion depth. Its chemical formula is C₁₈H₃₂O₁₆ (University of Hertfordshire 2014; ChEBI 2015; Kadam, Tiwari and O'Donnell 2015).

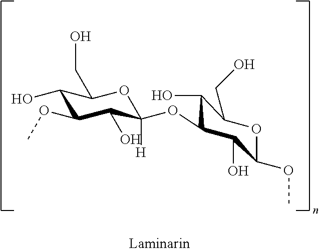

Laminarin is generally extracted from brown algae of the Pheophyceae type, and in particular the Fucales or the Laminariales. Laminarin is known to be used as a seed germinator and plant growth accelerator (biostimulant).

Laminarin can be extracted starting from a raw material consisting of brown algae, especially using the method disclosed in the French patent FR 9208387. The formulated product for laminarin (EPA registered) contains 3.51% laminarin as the active ingredient, surfactant (<10%) and two different preservatives (each <1%) that are permitted for use as food additives.

The challenge involved in developing a process and commercially acceptable composition for the improvement in the yield, disease management and post-harvest quality of agriculture produce continues to increase due to the rapid emergence of more complex customer and regulatory requirements. The method and composition must improve the yield and quality of agricultural produce. This emerging area of performance is critical to customer satisfaction and commercial success of a product. At the same time the demand on the agrochemical composition performance has been increasing.

During the last few decades, several chemical compounds or plant and microbial extracts have been known for use in several crops as plant resistance activators, plant defence activators, or elicitors. They have a broad target spectrum, although factors such as plant genotype, stage of growth, environmental conditions, timing and way of application may affect their performance against plant pathogens. Recently, interest in the use of extracts and essential oils for their antimicrobial activity has increased because these are considered to be safe for both the environment and human health.

Sea-weed extracts having shelf-life extension property is known, however, there is still a need to provide an improvement in yield, disease management and extending shelf life of post-harvest agricultural produce.

Hence, the problem of providing an effective method and composition to improve the yield, disease management and post-harvest quality of agricultural produce still remains. In the present invention a method, composition, and its use to improve the yield, disease management and post-harvest quality of agricultural produce are disclosed.

In accordance with the problems described herein, an objective of the present invention is to provide a method for improving the yield, disease management and post-harvest quality of agricultural produce.

Another objective of the present invention is to provide a method of improving the post-harvest vigor of the agricultural produce.

Another objective of the present invention is to provide a method of improving the post-harvest disease management of the agricultural produce.

An objective of the present invention is to provide a composition for improving the yield, disease management and post-harvest quality of agricultural produce.

Another objective of the present invention is to provide a method of improving the yield, disease management and post-harvest quality of agricultural produce with laminarin or a composition comprising laminarin.

These and other advantages of the present invention would be apparent from the description of the invention set out hereinafter.

### SUMMARY OF THE INVENTION

In an aspect, the present invention provides a method for improving yield, disease management and post-harvest quality of a crop, a plant or an agricultural produce using laminarin or a composition comprising laminarin. The method comprises contacting laminarin with agricultural produce or crop at pre-harvest stage. Said method comprises attaining atleast one of the following attributes or changes in the crop, the plant or the agricultural produce:
i) increase in the yield of the plant, the crop or the agricultural produce;
ii) increased pre-harvest disease management and control of the plant, the crop or the agricultural produce;
iii) increased post-harvest weight, shelf-life and/or vigor of agricultural produce;
iv) decreased post-harvest disease incidence and pest severity;
v) decreased post-harvest degradation and weight losses of agricultural produce; and/or
vi) decreased post-harvest nutrient loss; and/or
vii) increased nutrient content or post-harvest nutrient content.

In an aspect, the application rate of the laminarin ranges from 10-200 g.a.i/ha.

In an aspect, the agricultural produce is selected from crops, cereals, legumes, fruits, vegetables and cut flowers.

In another aspect, laminarin is applied alone or in combination with one or more additional agrochemically active agents selected from a fungicide, an insecticide, an anti-sprout agent, a post-harvest agent, an algicide, a biological agent, a biostimulant, or a combination thereof. In an aspect, laminarin is applied in combination with one or more fungicidal treatments. The fungicide is selected from cyazofamid, mandipropamide, boscalid, pyrimethanil, kresoxim, kresoxim-methyl, azoxystrobin, difenoconazole, metiram, pyraclostrobin, procymidone, mancozeb, potassium bicarbonate, triflumizole, fluxapyroxad, bixafen, fluindapyr, prothioconazole, propamocarb, fluazinam, copper, copper-based products and salts thereof, captan, folpet, fluopyram, fluoxastrobin, chlorothalonil, sulphur, Bacillus spp., tebuconazole, or combinations thereof. In an aspect, laminarin is applied in combination with one or more additional agrochemically active agents, preferably fungicidal treatments jointly, separately, as a premix, tank-mix or in a sequential manner.

In another aspect, there is provided a method of improving the post-harvest vigor and post-harvest disease control of a crop, a plant or an agricultural produce comprising contacting laminarin or a composition comprising laminarin with the crop, the plant or the agricultural produce at pre-harvest stage.

In another aspect, the present invention provides a composition comprising laminarin for improving yield, disease management and post-harvest quality of an agricultural produce. In an aspect said composition further comprises an agriculturally acceptable carrier or vehicle. In an aspect said composition further comprises an additional agrochemically active agent. In an aspect, said composition is combined or applied with compositions comprising an additional agrochemically active agent.

In an aspect, the present invention provides a composition for improving yield, disease management and post-harvest quality of a crop, a plant or an agricultural produce comprising:
a. laminarin; and
b. agriculturally acceptable carrier or vehicle.

In yet another aspect, the present invention provides a composition for improving yield, disease management and post-harvest quality of a crop, a plant or an agricultural produce comprising:
a. laminarin; and
b. an agrochemically active agent.

In another aspect, the present invention provides use of laminarin or a composition comprising laminarin for improving yield, disease management and post-harvest quality of a crop, a plant or an agricultural produce. In another aspect, the present invention provides use of laminarin for improving post-harvest vigor and post-harvest disease control of an agricultural produce.

In another aspect, the present invention provides a use of a combination of laminarin or a composition comprising laminarin and an agrochemically active agent for improving yield, disease management and post-harvest quality of a crop, a plant or an agricultural produce. The agrochemically active agent is a fungicide.

Yet another aspect of the present invention provides a combination comprising laminarin and an additional agrochemically active agent. In an aspect, the additional agrochemically active agent is a fungicide. In an aspect, the present invention provides a combination comprising laminarin and an additional fungicide. Preferred additional fungicide is selected from cyazofamid, mandipropamide, boscalid, pyrimethanil, kresoxim, kresoxim-methyl, azoxystrobin, difenoconazole, metiram, pyraclostrobin, procymidone, mancozeb, potassium bicarbonate, triflumizole, fluxapyroxad, bixafen, fluindapyr, prothioconazole, propamocarb, fluazinam, copper, copper-based products and salts thereof, captan, folpet, fluopyram, fluoxastrobin, chlorothalonil, sulphur, Bacillus spp., tebuconazole, or combinations thereof. In an aspect, said combination of the present invention is a pre-mix combination, a tank-mix combination, or a sequential combination. In an aspect, laminarin and the additional fungicide are combined in a ratio of 1:100 to 100:1. In an aspect, said combinations are suitable for improvement in yield, disease management and post-harvest quality of a crop, a plant or an agricultural produce characterized by at least one of:
i) increase in the yield of the plant, the crop or the agricultural produce;
ii) increased pre-harvest disease management and control of the plant, the crop or the agricultural produce;
iii) increased post-harvest weight, shelf-life and/or vigor of agricultural produce;
iv) decreased post-harvest disease incidence and pest severity;
v) decreased post-harvest degradation and weight losses of agricultural produce; and/or
vi) decreased post-harvest nutrient loss; and/or
vii) increased nutrient content or post-harvest nutrient content.

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified process parameters or composition that may of course, vary. It is also to be understood that the terminology used herein is for the purpose of describing embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

Various embodiments of the invention describe improving yield, disease management and post-harvest quality of a crop, a plant or an agricultural produce using laminarin or a composition comprising laminarin.

In an embodiment, there is provided a method for improving the yield, disease management and post-harvest quality of a crop, a plant or an agricultural produce using laminarin or a composition comprising laminarin. The method comprises the steps of contacting laminarin with the agricultural produce or crop at pre-harvest stage. Pre-harvest stage refers to the developmental stage which includes pre-sowing, sowing/planting, pre-emergence, and post-emergence stages.

In an embodiment, the application rate of the laminarin ranges from 10-200 g.a.i/ha.

In an embodiment, the application rate of the laminarin ranges from 10-200 g.a.i/ha. Preferably the application rate of the composition ranges from 10-170 g.a.i/ha. Preferably, the application rate of the composition is 36 g.a.i/ha. Preferably, the application rate of the composition is 90 g.a.i/ha. Preferably, the application rate of the composition is 56.6 g.a.i/ha. Preferably, the application rate of the composition is 154 g.a.i/ha.

In an embodiment, the application rate of the laminarin ranges from 10-200 g.a.i/ha. Preferably, the application rate of the composition ranges from 50-150 g.a.i/ha. More preferably, the application rate of the composition is 90 g.a.i/ha. More preferably, the application rate of the composition is 56.6 g.a.i/ha

In an embodiment, the improvement in yield, disease management and post-harvest quality of a crop, a plant or an agricultural produce is characterized by one or more of following attributes or changes in the crop, the plant or the agricultural produce:
i) increase in the yield of the plant, the crop or the agricultural produce;
ii) increased pre-harvest disease management and control of the plant, the crop or the agricultural produce;
iii) increased post-harvest weight, shelf-life and/or vigor of agricultural produce;
iv) decreased post-harvest disease incidence and pest severity;
v) decreased post-harvest degradation and weight losses of agricultural produce; and/or
vi) decreased post-harvest nutrient loss; and/or
vii) increased nutrient content or post-harvest nutrient content.

In an embodiment, said method comprising contacting laminarin with the crop, the plant or the agricultural produce or crop comprises attaining atleast one of the following attributes or changes in the crop, the plant or the agricultural produce:
i) increase in the yield of the plant, the crop or the agricultural produce;
ii) increased pre-harvest disease management and control of the plant, the crop or the agricultural produce;
iii) increased post-harvest weight, shelf-life and/or vigor of agricultural produce;
iv) decreased post-harvest disease incidence and pest severity;
v) decreased post-harvest degradation and weight losses of agricultural produce; and/or
vi) decreased post-harvest nutrient loss; and/or
vii) increased nutrient content or post-harvest nutrient content.

The terms “increase”, “increased”, “increasing”, “decrease”, “decreased”, “decreasing”, “improve”, “improved”, “improving” and “improvement” denote a change when laminarin is applied or when an agricultural produce, a plant or a crop is contacted with laminarin or a composition comprising laminarin. Said change is in reference with an agricultural produce, a plant or a crop not treated with laminarin or an agricultural produce, a plant or a crop treated with any agrochemically active agent not comprising laminarin.

In an embodiment, the yield of the crop, the plant or the agricultural produce is increased when laminarin is applied in pre-harvest stage.

In an embodiment, the disease management and control are increased when laminarin is applied in pre-harvest stage.

In an embodiment, post-harvest quality and vigor is increased when laminarin is applied in pre-harvest stage. The resultant agricultural produce stays fresh longer for upto 90 days after harvest.

In an embodiment, post-harvest disease incidence and pest severity is reduced whereas disease control is increased when laminarin is applied in pre-harvest stage.

In an embodiment, post-harvest degradation and weight losses of agricultural produce are minimised when laminarin is applied in pre-harvest stage.

In an embodiment, the agricultural produce is selected from crops, cereals, legumes, fruits, vegetables and cut flowers and the post-harvest quality of the agriculture produce is determined by factors selected from post-harvest weight losses; decay due to disease (esp. fungal diseases); size, shape, smell, feel and colour of the produce; post-harvest vigor, shelf-life, nutrition content, BRIX values, peeling, bruising, storage stability; resistance to enzymatic degradation and physical damage such as bruising, shrinkage, peel resistance, and sprouting.

Degrees Brix or °Brix (Brix) is a measure of the total soluble solids (TSS) present in the fruit. TSS is mainly made up of sugars but also includes other compounds. The total soluble solids are made up of
Sugars, which can be monosaccharides, disaccharides, or oligosaccharides, such as sucrose, fructose, etc.
Organic acids, such as citric, malic, tartaric acids etc.
Soluble amino acids, but not proteins as they are not soluble.
Other miscellaneous compounds, such as fat, minerals, alcohol, flavonoids (Vitamin C and Vitamin A), etc.

Brix can be used as a measure of maturity, flavour, and level of sweetness in fruits and vegetables to help in fixing the time of harvest, sales, and processing.

In an embodiment, the stage of application of laminarin depends on the type of crop involved. The improved quality of the agriculture produce comprises reduced post-harvest weight loss of the agricultural produce, reduced decay due to disease and protection of the agricultural produce from pathogen attack, resistance to pathogen attack and disease by the agricultural produce, improved size, shape, smell, texture, feel and colour of the agricultural produce, improved post-harvest vigor and shelf-life of the agricultural produce, reduction in nutrient content degradation/deterioration of the agricultural produce.

In an embodiment, the laminarin is applied alone or in combination with additional agrochemically active agents. The additional agrochemically active agents are selected from a fungicide, an insecticide, an anti-sprout agent, a post-harvest agent, an algicide, a biological agent, a biostimulant, or a combination thereof.

In an embodiment, laminarin may be applied in a combination of treatments comprising one or more additional agrochemically active agents selected from fungicides, insecticides, post-harvest agents, anti-sprout agents, biologicals, biostimulants, and/or combinations thereof.

In an embodiment, laminarin may be applied in combination with two additional agrochemically active agents. In an embodiment, laminarin may be applied in combination with three additional agrochemically active agents. In an embodiment, laminarin may be applied in combination with four additional agrochemically active agents. In an embodiment, laminarin may be applied in combination with five additional agrochemically active agents. In an embodiment, laminarin may be applied in combination with six additional agrochemically active agents.

The additional agrochemically active agent alone or collectively may be applied in a range of 0.1-10,000 g ai/ha, more particularly in a range of 10 g ai/ha to 5000 g ai/ha.

In an embodiment, the application may be carried out as a premix, tank-mix or in a sequential manner. In sequential treatments, the treatment of laminarin standalone or in a combination with additional agrochemically active agents may be carried out in immediate succession or staggered sequence or in regular intervals separated by definite time periods.

In an embodiment, laminarin and the additional agrochemically active agents or compositions comprising them may be applied simultaneously, that is jointly or separately, or in succession.

In an embodiment, laminarin may be applied in a combination of treatments comprising one or more fungicides, wherein the fungicide may be selected from the group consisting of:
I. an aliphatic nitrogen fungicide selected from the group consisting of butylamine, cymoxanil, dodicin, dodine, guazatine, iminoctadine, seboctylamine and combinations thereof;
II. an amide fungicide selected from the group consisting of carpropamid, chloraniformethan, cyclobutrifluram, cyflufenamid, diclocymet, diclocymet, dimoxystrobin, fenaminstrobin, fenoxanil, flumetover, isofetamid, mandestrobin, mandipropamid, metominostrobin, orysastrobin, prochloraz, quinazamid, silthiofam, triforine, trimorphamide and combinations thereof;
III. an acylamino acid fungicide selected from the group consisting of benalaxyl, benalaxyl-M, furalaxyl, metalaxyl, metalaxyl-M, pefurazoate, valifenalate and combinations thereof;
IV. an anilide fungicide selected from the group consisting of benalaxyl, benalaxyl-M, bixafen, boscalid, carboxin, fenhexamid, flubeneteram, fluxapyroxad, isotianil, metalaxyl, metalaxyl-M, metsulfovax, ofurace, oxadixyl, oxycarboxin, penflufen, pyracarbolid, pyraziflumid, sedaxane, thifluzamide, tiadinil, vangard and combinations thereof;
V. a benzanilide fungicide selected from the group consisting of benodanil, flufenoxadiazam, flutolanil, mebenil, mepronil, salicylanilide, tecloftalam and combinations thereof;
VI. a furanilide fungicide selected from the group consisting of fenfuram, furalaxyl, furcarbanil, methfuroxam and combinations thereof;
VII. a sulfonanilide fungicide selected from the group consisting of flusulfamide, tolnifanide and combinations thereof;
VIII. a benzamide fungicide selected from the group consisting of benzohydroxamic acid, fluopicolide, fluopimomide, fluopyram, tioxymid, trichlamide, zarilamid, zoxamide and combinations thereof;
IX. a furamide fungicide selected from the group consisting of cyclafuramid, furmecyclox and combinations thereof;
X. a phenylsulfamide fungicide selected from the group consisting of dichlofluanid, tolylfluanid and combinations thereof;
XI. a picolinamide fungicide selected from the group consisting of fenpicoxamid, florylpicoxamid, metarylpicoxamid and combinations thereof;
XII. a pyrazolecarboxamide fungicide selected from the group consisting of benzovindiflupyr, bixafen, flubeneteram, fluindapyr, fluxapyroxad, furametpyr, inpyrfluxam, isopyrazam, penflufen, penthiopyrad, pydiflumetofen, pyrapropoyne, sedaxane and combinations thereof;
XIII. a sulfonamide fungicide selected from the group consisting of amisulbrom, cyazofamid, dimefluazole and combinations thereof;
XIV. a valinamide fungicide selected from the group consisting of benthiavalicarb, iprovalicarb and combinations thereof;
XV. an antibiotic fungicide selected from the group consisting of aureofungin, blasticidin-S, cycloheximide, fenpicoxamid, griseofulvin, kasugamycin, moroxydine, natamycin, ningnanmycin, polyoxins, polyoxorim, streptomycin, validamycin and combinations thereof;
XVI. a strobilurin fungicide selected from the group consisting of fluoxastrobin, mandestrobin, pyribencarb, azoxystrobin, bifujunzhi, coumoxystrobin, enoxastrobin, flufenoxystrobin, jiaxiangjunzhi, picoxystrobin, pyraoxystrobin, pyraclostrobin, pyrametostrobin, triclopyricarb, dimoxystrobin, fenaminstrobin, metominostrobin, orysastrobin, kresoxim-methyl, trifloxystrobin and combinations thereof;
XVII. an aromatic fungicide selected from the group consisting of biphenyl, chlorodinitronaphthalenes, chloroneb, chlorothalonil, cresol, dicloran, fenjuntong, hexachlorobenzene, pentachlorophenol, quintozene, sodium pentachlorophenate, tecnazene, thiocyanatodinitrobenzenes, trichlorotrinitrobenzenes and combinations thereof;
XVIII. an arsenical fungicide selected from the group consisting of asomate, urbacide and combinations thereof;
XIX. an aryl phenyl ketone fungicide selected from the group consisting of metrafenone, pyriofenone and combinations thereof;
XX. a benzimidazole fungicide selected from the group consisting of albendazole, benomyl, carbendazim, chlorfenazole, cypendazole, debacarb, dimefluazole, fuberidazole, mecarbinzid, rabenzazole, thiabendazole and combinations thereof;
XXI. a benzimidazole precursor fungicide selected from the group consisting of furophanate, thiophanate, thiophanate-methyl and combinations thereof;
XXII. a benzothiazole fungicide selected from the group consisting of bentaluron, benthiavalicarb, benthiazole, chlobenthiazone, dichlobentiazox, probenazole and combinations thereof;
XXIII. a botanical fungicide selected from the group consisting of allicin, berberine, carvacrol, carvone, osthol, sanguinarine, santonin and combinations thereof;
XXIV. a bridged diphenyl fungicide selected from the group consisting of bithionol, dichlorophen, diphenylamine, hexachlorophene, parinol and combinations thereof;
XXV. a carbamate fungicide selected from the group consisting of benthiavalicarb, furophanate, iodocarb, iprovalicarb, picarbutrazox, propamocarb, pyribencarb, thiophanate, thiophanate-methyl, tolprocarb and combinations thereof;
XXVI. a benzimidazolylcarbamate fungicide selected from the group consisting of albendazole, benomyl, carbendazim, cypendazole, debacarb, mecarbinzid and combinations thereof;
XXVII. a carbanilate fungicide selected from the group consisting of diethofencarb, pyraclostrobin, pyrametostrobin, triclopyricarb and combinations thereof;
XXVIII. a conazole fungicide selected from the group consisting of climbazole, clotrimazole, imazalil, oxpoconazole, prochloraz, triflumizole, viniconazole, azaconazole, bromuconazole, cyproconazole, diclobutrazol, difenoconazole, diniconazole, diniconazole-M, epoxiconazole, etaconazole, fenbuconazole, fluoxytioconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P and combinations thereof;
XXIX. a copper fungicide selected from the group consisting of acypetacs-copper, basic copper carbonate, basic copper sulfate, Bordeaux mixture, Burgundy mixture, Cheshunt mixture, copper acetate, copper hydroxide, copper naphthenate, copper oleate, copper oxychloride, copper silicate, copper sulfate, copper zinc chromate, cufraneb, cuprobam, cuprous oxide, mancopper, oxine-copper, saisentong, thiodiazole-copper and combinations thereof;
XXX. a cyanoacrylate fungicide selected from the group consisting of benzamacril, phenamacril and combinations thereof;
XXXI. a dicarboximide fungicide selected from the group consisting of famoxadone, fluoroimide and combinations thereof;
XXXII. a dichlorophenyl dicarboximide fungicide selected from the group consisting of chlozolinate, dichlozoline, dimetachlone, iprodione, isovaledione, metomeclan, myclozolin, procymidone, vinclozolin and combinations thereof;
XXXIII. a phthalimide fungicide selected from the group consisting of captafol, captan, ditalimfos, folpet, thiochlorfenphim and combinations thereof;
XXXIV. a dinitrophenol fungicide selected from the group consisting of binapacryl, dinobuton, dinocap, dinocap-4, dinocap-6, meptyldinocap, dinocton, dinopenton, dinosulfon, dinoterbon, DNOC and combinations thereof;
XXXV. a dithiocarbamate fungicide selected from the group consisting of amobam, asomate, azithiram, carbamorph, cufraneb, cuprobam, disulfiram, ferbam, manam, metam, nabam, tecoram, thiram, urbacide, ziram, dazomet, etem, milneb, mancopper, mancozeb, maneb, metiram, polycarbamate, propineb, zineb and combinations thereof;
XXXVI. a dithiolane fungicide selected from the group consisting of isoprothiolane, saijunmao and combinations thereof;
XXXVII. a fumigant fungicide selected from the group consisting of allyl isothiocyanate, carbon disulfide, cyanogen, dimethyl disulfide, methyl bromide, methyl iodide, methyl isothiocyanate, sodium tetrathiocarbonate and combinations thereof;
XXXVIII. a hydrazide fungicide selected from the group consisting of benquinox, chloroinconazide, saijunmao and combinations thereof;
XXXIX. an imidazole fungicide selected from the group consisting of cyazofamid, fenamidone, fenapanil, glyodin, iprodione, isovaledione, pefurazoate, triazoxide, climbazole, clotrimazole, imazalil, oxpoconazole, prochloraz, triflumizole, viniconazole and combinations thereof;
XL. an inorganic fungicide selected from the group consisting of potassium azide, potassium thiocyanate, sodium azide, sulfur and combinations thereof;
XLI. a mercury fungicide selected from the group consisting of mercuric chloride, mercuric oxide, mercurous chloride, (3-ethoxypropyl) mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulfonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate and combinations thereof;
XLII. a morpholine fungicide selected from the group consisting of aldimorph, benzamorf, carbamorph, dimethomorph, dodemorph, fenpropimorph, flumorph, tridemorph, trimorphamide and combinations thereof;
XLIII. an organophosphorus fungicide selected from the group consisting of ampropylfos, ditalimfos, EBP, edifenphos, fosetyl, hexylthiofos, inezin, iprobenfos, izopamfos, kejunlin, phosdiphen, pyrazophos, tolclofos-methyl, triamiphos and combinations thereof;
XLIV. an organotin fungicide selected from the group consisting of decafentin, fentin, tributyltin oxide and combinations thereof;
XLV. an oxathiin fungicide selected from the group consisting of carboxin, oxycarboxin and combinations thereof;
XLVI. an oxazole fungicide selected from the group consisting of chlozolinate, dichlozoline, drazoxolon, famoxadone, fluoxapiprolin, hymexazol, metazoxolon, myclozolin, oxadixyl, oxathiapiprolin, pyrisoxazole, vinclozolin and combinations thereof;
XLVII. a polysulfide fungicide selected from the group consisting of barium polysulfide, calcium polysulfide, potassium polysulfide, sodium polysulfide and combinations thereof;
XLVIII. a pyrazole fungicide selected from the group consisting of oxathiapiprolin, fluoxapiprolin, rabenzazole, fenpyrazamine, metyltetraprole, pyraclostrobin, pyrametostrobin, pyraoxystrobin, benzovindiflupyr, bixafen, flubeneteram, fluindapyr, fluxapyroxad, furametpyr, inpyrfluxam, isoflucypram, isopyrazam, penflufen, penthiopyrad, pydiflumetofen, sedaxane and combinations thereof;
XLIX. a pyridazine fungicide such as pyridachlometyl;
L. a pyridine fungicide selected from the group consisting of aminopyrifen, boscalid, buthiobate, cyclobutrifluram, dipyrithione, fluazinam, fluopicolide, fluopyram, parinol, picarbutrazox, pyribencarb, pyridinitril, pyrifenox, pyrisoxazole, pyroxychlor, pyroxyfur, triclopyricarb and combinations thereof;
LI. a pyrimidine fungicide selected from the group consisting of bupirimate, diflumetorim, dimethirimol, ethirimol, fenarimol, ferimzone, flumetylsulforim, nuarimol, triarimol and combinations thereof;
LII. an anilinopyrimidine fungicide selected from the group consisting of cyprodinil, mepanipyrim, pyrimethanil and combinations thereof;
LIII. a pyrrole fungicide selected from the group consisting of dimetachlone, fenpiclonil, fludioxonil, fluoroimide, metomeclan and combinations thereof;
LIV. a quaternary ammonium fungicide selected from the group consisting of berberine, sanguinarine and combinations thereof;
LV. a quinoline fungicide selected from the group consisting of ethoxyquin, halacrinate, 8-hydroxyquinoline sulfate, ipflufenoquin, quinacetol, quinofumelin, quinoxyfen, tebufloquin and combinations thereof;
LVI. a quinone fungicide selected from the group consisting of chloranil, dichlone, dithianon and combinations thereof;
LVII. a quinoxaline fungicide selected from the group consisting of chinomethionat, chlorquinox, thioquinox and combinations thereof;
LVIII. a tetrazole fungicide selected from the group consisting of metyltetraprole, picarbutrazox and combinations thereof;
LIX. a thiadiazole fungicide selected from the group consisting of etridiazole, saisentong, thiodiazole-copper, zinc thiazole and combinations thereof;
LX. a thiazole fungicide selected from the group consisting of dichlobentiazox, ethaboxam, fluoxapiprolin, isotianil, metsulfovax, octhilinone, oxathiapiprolin, thiabendazole, thifluzamide and combinations thereof;
LXI. a thiazolidine fungicide selected from the group consisting of flutianil, thiadifluor and combinations thereof;
LXII. a thiocarbamate fungicide selected from the group consisting of methasulfocarb, prothiocarb and combinations thereof;
LXIII. a thiophene fungicide selected from the group consisting of ethaboxam, isofetamid, penthiopyrad, silthiofam, thicyofen and combinations thereof;
LXIV. a triazine fungicide selected from the group consisting of anilazine and combinations thereof;
LXV. a triazole fungicide selected from the group consisting of amisulbrom, bitertanol, fluotrimazole, triazbutil, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P and combinations thereof;
LXVI. a triazolopyrimidine fungicide selected from the group consisting of ametoctradin, mepitriflufenpyr and combinations thereof;
LXVII. a urea fungicide selected from the group consisting of bentaluron, pencycuron, quinazamid and combinations thereof;
XVIII. a zinc fungicide selected from the group consisting of acypetacs-zinc, copper zinc chromate, cufraneb, mancozeb, metiram, polycarbamate, polyoxorim-zinc, propineb, zinc naphthenate, zinc thiazole, zinc trichlorophenate, zineb, ziram and combinations thereof; and/or
LXIX. a fungicide of unknown class selected from the group consisting of acibenzolar, acypetacs, allyl alcohol, benzalkonium chloride, bethoxazin, bromothalonil, cetoctaelat, chitosan, chloropicrin, DBCP, dehydroacetic acid, diclomezine, diethyl pyrocarbonate, dipymetitrone, ethylicin, fenaminosulf, fenitropan, fenpropidin, formaldehyde, furfural, hexachlorobutadiene, nitrostyrene, nitrothal-isopropyl, OCH, oxyfenthiin, pentachlorophenyl laurate, 2-phenylphenol, phthalide, piperalin, propamidine, proquinazid, pyroquilon, sodium o-phenylphenoxide, spiroxamine, sultropen, tricyclazole and combinations thereof.

In a preferred embodiment, laminarin may be applied in combination with one or more fungicidal treatments, wherein the fungicides are selected from the group consisting of mancozeb, difenoconazole, boscalid, pirimetanil (pyrimetanil), procymidone (procimidone), kresoxim, kresoxim-methyl, azoxystrobin, metiram, pyraclostrobin, cyazofamid, mandipropamide, triflumizole, potassium bicarbonate, and combinations thereof.

In another preferred embodiment, the fungicide is selected from the group consisting of fluxapyroxad, bixafen, fluindapyr, prothioconazole, propamocarb, fluazinam, copper, copper based products and salts thereof, captan, folpet, fluopyram, fluoxastrobin, chlorotalonil, sulphur, Bacillus spp., tebuconazole and combinations thereof.

In an embodiment, laminarin may be applied in combination with two fungicidal treatments. In an embodiment, laminarin may be applied in combination with three fungicidal treatments. In an embodiment, laminarin may be applied in combination with four fungicidal treatments.

In an embodiment, laminarin may be applied in combination with five fungicidal treatments. In an embodiment, laminarin may be applied in combination with six fungicidal treatments.

In another embodiment, the present invention provides a method for improving yield, disease management and post-harvest quality of a crop, a plant or an agricultural produce with a composition comprising laminarin. The method involves the steps of contacting the agricultural produce, the plant or the crop with a composition comprising laminarin at pre-harvest stage. Pre-harvest stage refers to the developmental stage which includes pre-sowing, sowing/planting, pre-emergence and post-emergence stages.

The application rate of the composition comprising laminarin ranges from 0.1-20 kg or l/ha.

Preferably, the application rate of the composition ranges from 0.1-10 kg or l/ha. More preferably, the application rate of the composition is 2 kg or l/ha.

In another embodiment, the composition comprises laminarin and at least one additional agrochemically active agent.

In another embodiment, the composition comprising laminarin may be applied in combination with other compositions comprising at least one additional agrochemically active agent.

The additional agrochemically active agent is selected from a fungicide, an insecticide, an anti-sprout agent, a post-harvest agent, an algicide, a biological agent, a biostimulant, or a combination thereof. The fungicide is selected from copper fungicides, dithiocarbamate fungicides, thalimide fungicides, chloronitrile fungicides, sulfamide fungicides, guanidine fungicides, triazines fungicides and quinone fungicides.

In an embodiment, the fungicide is selected from the group consisting of mancozeb, difenoconazole, boscalid, pirimetanil (pyrimetanil), procymidone (procimidone), kresoxim, kresoxim-methyl, azoxystrobin, metiram, pyraclostrobin, cyazofamid, mandipropamide, triflumizole, potassium carbonate, and combinations thereof.

In an embodiment, the fungicide is selected from the group consisting of fluxapyroxad, bixafen, fluindapyr, prothioconazole, propamocarbe, fluazinam, copper, copper-based products and salts thereof, captan, folpet, fluopyram, fluoxastrobin, chlorotalonil, sulphur, Bacillus spp., tebuconazole, and combinations thereof.

The application rate of the composition comprising the agrochemically active agent ranges from 0.1-20 kg or l/ha.

The concentration of laminarin in the composition ranges from 10%-80% w/w of total composition, and preferably from 20%-70% w/w, and more preferably from 30%-60% w/w of laminarin. Preferably, the concentration ranges from about 40%-50% w/w of total composition.

In a preferred embodiment, the concentration of laminarin is about 45% w/w of total composition.

The concentration of the agrochemically active agent ranges from 10-90% w/w, and preferably from 30%-70% w/w, and more preferably from 50%-60% w/w of the composition.

In an embodiment, laminarin, is applied alone or in combination with additional agrochemically active agents such as a fungicide, an insecticide, an anti-sprout agent, a post-harvest agent, an algicide, a biological agent, a biostimulant and/or combinations thereof plays an important role in improving the yield, disease management and post-harvest quality of agricultural produce. The active ingredients laminarin and the additional agrochemically active agent or compositions comprising them may be applied as a tank-mix or a premix composition. The active ingredients laminarin and the additional agrochemically active agent may be applied in immediate succession in any order or in a staggered succession wherein the applications are separated out by specific time periods.

In an embodiment, the present invention provides a combination comprising laminarin and an additional agrochemically active agent. In an embodiment, the additional agrochemically active agent is a fungicide. In an embodiment, the present invention provides a combination comprising laminarin and an additional fungicide. The additional fungicide may be one or more fungicides selected from groups I to LXIX provided in the above embodiments. Preferred additional fungicide is selected from cyazofamid, mandipropamide, boscalid, pyrimethanil, kresoxim, kresoxim-methyl, azoxystrobin, difenoconazole, metiram, pyraclostrobin, procymidone, mancozeb, potassium bicarbonate, triflumizole, fluxapyroxad, bixafen, fluindapyr, prothioconazole, propamocarb, fluazinam, copper, copper-based products and salts thereof, captan, folpet, fluopyram, fluoxastrobin, chlorothalonil, sulphur, Bacillus spp., tebuconazole, or combinations thereof.

In an embodiment, said combination of the present invention is a pre-mix combination, a tank-mix combination, or a sequential combination. Said combination also refers to the combination of actives at the target site when applied separately or in a sequential manner. In an embodiment, the combination is a combination of a treatment comprising laminarin with a treatment comprising an additional fungicide. In an embodiment, the combination is a combination of a composition comprising laminarin and a composition comprising an additional fungicide. The composition comprising the additional fungicide may comprise one or more fungicides in a single composition or they may be separate compositions.

In an embodiment, laminarin and the additional fungicide may be combined in a ratio of 1:100 to 100:1. Preferably, laminarin and the additional fungicide may be combined in a ratio of 1:75 to 75:1. More preferably, laminarin and the additional fungicide may be combined in a ratio of 1:50 to 50:1. In an preferred embodiment, laminarin and the additional fungicide may be combined in a ratio of 1:30 to 30:1.

An embodiment of the present invention provides a combination of laminarin and two additional fungicides. An embodiment of the present invention provides a combination of laminarin and three additional fungicides. An embodiment of the present invention provides a combination of laminarin and three additional fungicides. An embodiment of the present invention provides a combination of laminarin and four additional fungicides. An embodiment of the present invention provides a combination of laminarin and five additional fungicides. An embodiment of the present invention provides a combination of laminarin and six additional fungicides. The fungicides or combinations thereof may be selected from the fungicides provided in the embodiments of the present invention.

A preferred embodiment of the present invention provides a combination of laminarin and cyazofamid.

A preferred embodiment of the present invention provides a combination of laminarin and mandipropamide.

A preferred embodiment of the present invention provides a combination of laminarin and boscalid.

A preferred embodiment of the present invention provides a combination of laminarin and pyrimethanil.

A preferred embodiment of the present invention provides a combination of laminarin and azoxystrobin.

A preferred embodiment of the present invention provides a combination of laminarin and difenoconazole.

A preferred embodiment of the present invention provides a combination of laminarin and metiram.

A preferred embodiment of the present invention provides a combination of laminarin and pyraclostrobin.

A preferred embodiment of the present invention provides a combination of laminarin and procimidone.

A preferred embodiment of the present invention provides a combination of laminarin and mancozeb.

A preferred embodiment of the present invention provides a combination of laminarin and kresoxim-methyl.

A preferred embodiment of the present invention provides a combination of laminarin and triflumizole.

A preferred embodiment of the present invention provides a combination of laminarin and potassium bicarbonate.

A preferred embodiment of the present invention provides a combination of laminarin, mandipropamide and cyazofamid.

A preferred embodiment of the present invention provides a combination of laminarin, boscalid and pyrimethanil.

A preferred embodiment of the present invention provides a combination of laminarin, boscalid and kresoxim or kresoxim-methyl.

A preferred embodiment of the present invention provides a combination of laminarin, azoxystrobin and difenoconazole.

A preferred embodiment of the present invention provides a combination of laminarin, metiram and pyraclostrobin.

A preferred embodiment of the present invention provides a combination of laminarin, procimidone and pyrimethanil.

A preferred embodiment of the present invention provides a combination of laminarin, mancozeb and difenoconazole.

A preferred embodiment of the present invention provides a combination of laminarin, boscalid kresoxim or kresoxim-methyl, azoxystrobin, difenoconazole, metiram and pyraclostrobin.

In an embodiment, the combinations of the present invention result in improved yield, disease management and post-harvest quality of produce. Said combinations also provide better effects than fungicide treatments alone. It was also observed that when laminarin was combined with reduced dose of fungicide treatments or reduced number of fungicide treatment applications, the control of disease, improvement in yield and post-harvest quality observed was at par with complete dose of fungicide treatment. Thus, the combinations of the present invention provide an advantage by reducing the amount of fungicide used or applied.

In an embodiment, the present invention provides a composition comprising laminarin for improving the yield, disease management and post-harvest quality of a crop, a plant or an agricultural produce. The composition, containing an effective amount of laminarin, is optionally incorporated with an agriculturally acceptable carrier or vehicle.

In another embodiment, the present invention provides a composition comprising laminarin; and an agrochemically active agent for improving the yield, disease management and post-harvest quality of a crop, a plant or an agricultural produce. The agrochemically active agent is selected from a fungicide, an insecticide, an anti-sprout agent, a post-harvest agent, an algicide, a biological agent, a biostimulant, or a combination thereof.

The fungicide is selected from copper fungicides, dithiocarbamate fungicides, phthalamide fungicides, chloronitrile fungicides, sulfamide fungicides, guanidine fungicides, triazines fungicides and quinone fungicides.

The fungicide is selected from the group consisting of mancozeb, difenoconazole, boscalid, pirimetanil (pyrimetanil), procymidone (procimidone), kresoxim, kresoxim-methyl, azoxystrobin, metiram, pyraclostrobin, cyazofamid, mandipropamide, triflumizole, potassium bicarbonate, and combinations thereof.

In an embodiment, the fungicide is selected from the group consisting of fluxapyroxad, bixafen, fluindapyr, prothioconazole, propamocarb, fluazinam, copper, copper-based products and salts thereof, captan, folpet, fluopyram, fluoxastrobin, chlorotalonil, sulphur, Bacillus spp., tebuconazole and combinations thereof.

In an embodiment, there is provided a kit-of-parts comprising a component of laminarin and one or more components comprising the additional agrochemically active agents. The component comprising laminarin may be premixed with agriculturally acceptable carrier or vehicle or may be provided separately to be mixed at the time of application. The component comprising the additional agrochemically active agents may comprise all or some agrochemically active agents mixed together, with or without agriculturally acceptable carrier or vehicle. The kit-of-parts may comprise multiple components comprising the additional agrochemically active agents, which may or may not be mixed with agriculturally acceptable carrier or vehicle. The kit-o-parts may further comprise a set of instructions for application and method of mixing and applying the ingredients to an agricultural produce.

In an embodiment, the concentration of laminarin in the composition ranges from 10%-80% w/w of total composition. Preferably, the composition may contain from 20%-70% w/w of laminarin, and preferably from 30%-60% w/w of laminarin, and more preferably from 40%-50% w/w of laminarin based on the total weight of the composition. Most preferably the concentration of laminarin in the composition is about 45% w/w of laminarin.

The concentration of the agrochemically active agent ranges from 10-90% w/w, and preferably from 30%-70% w/w, and more preferably from 50%-60% w/w of the composition.

In an embodiment, the composition comprises an agriculturally acceptable carrier or vehicle, comprising carriers, diluents, surfactants, surface-active substances, emulsifiers, fillers, anti-foaming agents, anti-freezing agents, freezing agents and preservatives. The preservatives are selected from derivatives of benzoic acid, sorbic acid, formaldehyde, in particular potassium sorbate, a combination of methyl parahydroxybenzoate or propyl parahydroxybenzoate.

Exemplary antifreeze agent(s) added to the composition may be alcohols selected from the group comprising of but not limited to ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol.

Emulsifiers which can be advantageously employed herein can be readily determined by those skilled in the art and include various non-ionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulfonic acids, oil-soluble salts or sulfated polyglycol ethers and appropriate salts of phosphated polyglycol ether.

Exemplary antifoam agent(s) added to the composition are Polydimethoxysiloxane, polydimethylsiloxane, Alkyl poly acrylates, Castor Oil, Fatty Acids, Fatty Acids Esters, Fatty Acids Sulfate, Fatty Alcohol, Fatty Alcohol Esters, Fatty Alcohol Sulfate, Foot Olive Oil, Mono & Di Glyceride, Paraffin Oil, Paraffin Wax, Poly Propylene Glycol, Silicones Oil, Vegetable & Animal Fats, Vegetable & Animal Fats Sulfate, Vegetable & Animal Oil, Vegetable & Animal Oil Sulfate, Vegetable & Animal Wax, Vegetable & Animal Wax Sulfate, agents based on silicon or magnesium stearate. Examples of suitable solvents are, but not limited to, water, aromatic solvents (for example Solvesso products, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

Examples of suitable surfactants are, but not limited to, alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose. The surfactant may be non-ionic alkoxylates selected from C₁₀₋₁₂ alcohol (10 EO) Ethoxylate, Tridecyl alcohol (6EO) Ethoxylate, C₁₀ alcohol (5 EO) Ethoxylate, C₈ alcohol Ethoxylate (4 EO), C₉₋₁₁ alcohol Ethoxylate (4 EO), Isodecyl alcohol (7 EO) Ethoxylate or combination thereof. Preferred surfactant may be Dodecan-1-ol ethoxylated (23EO).

Examples of suitable carriers are, but not limited to, mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders, polyvinylpyrrolidone and other solid carriers.).

In another embodiment, the composition can be presented in solid form, especially in the form of powders, dusts or granules, water dispersible granules, microcapsules or wettable powders or in liquid form, for example, emulsifiable concentrates, solutions, emulsions or suspensions, ZC formulations, oil dispersions. In general terms, the compositions according to the invention are prepared by mixing laminarin with customary additives, for example solid fillers and/or solvents.

In other terms, the compositions according to the invention are prepared by mixing laminarin with at least one agrochemically active agents, and optionally with customary additives, for example solid fillers and/or solvents.

In an embodiment, the composition of the present invention may contain agriculturally acceptable carriers or vehicles such as adjuvants, carriers, diluents, surfactants, surface-active substances, emulsifiers, fillers, anti-foaming agents, anti-freezing agents, freezing agents, preservatives etc. Examples of solid fillers which can be used for the preparation of wettable powders or granules are finely divided kaolin or clay. The antifoamers/defoamers are optionally added in an amount from about 0.01% to about 2% w/w, preferably from about 0.1% to about 1.5% w/w of total weight of the composition.

The composition of the present invention can be used as such, in the form of their formulations or in the forms prepared therefrom by dilution of a concentrated form, such as ready to-use or concentrated solutions, suspensions, emulsions, powders, dusts, pastes and granules. They are used in the customary manner, for example by watering, spraying, atomizing, dusting, coating, dipping, broadcasting, or scattering.

In an embodiment the present invention provides for use of laminarin for improving yield, disease management and post-harvest quality of a crop, a plant or an agricultural produce. The use of laminarin comprises contacting laminarin with the agricultural produce, the plant or the crop at pre-harvest stage. Pre-harvest stage refers to the developmental stage which includes pre-sowing, sowing/planting, pre-emergence, and post-emergence stages.

As used herein, the harvest quality of the agriculture produce is determined by factors comprising post-harvest weight losses; decay due to disease (especially fungal diseases); size, shape, smell, feel and colour of the produce; post-harvest vigour, shelf-life, nutrition content, tolerance to peeling, resistance to bruising, storage stability; resistance to enzymatic degradation and physical damage such as bruising, shrinkage, peel resistance and sprouting. The improved harvest quality of the agriculture produce comprises reduced post-harvest weight loss of the agricultural produce, reduced decay due to disease and protection of the agricultural produce from pathogen attack, resistance to pathogen attack and disease by the agricultural produce, improved size, shape, smell, texture, feel and colour of the agricultural produce, improved post-harvest vigour and shelf-life of the agricultural produce.

In an embodiment, present invention provides a method of preserving the agricultural produce longer. There is provided a method of making the agricultural produce stay fresh for a longer period, suitable for storage, transportation, processing, distribution and consumption. The present invention provides an improved post-harvest quality with reduction in nutrient content degradation/deterioration of the agricultural produce and improved stability of the agricultural produce during storage, transportation, processing, distribution and consumption. The present invention provides a method of retaining the nutrient content in the produce for extended periods. The improved quality of the agricultural produce facilitates ease of storage, transportation, processing, distribution and consumption of the produce and lower costs associated with these activities. The present invention provides a method for retaining the freshness and vigor of the agricultural produce for a period upto 90 days. The present invention also provides a method for post-harvest disease management and control of the agricultural produce.

The improved post-harvest quality comprises improved resistance to enzymatic degradation, physical and environmental damage of the agricultural produce. It may refer to changes caused in the agricultural produce due to varied temperature, pH and humidity conditions to which the agricultural produce is subjected to during storage, transportation, processing, distribution and consumption. The is also provided a method of protecting the agricultural produce from damage such as bruising, peeling, shrinkage and sprouting. In an aspect there is also provided a method of improving the resistance of the agricultural produce to damage such as bruising, peeling, shrinkage and sprouting.

In an embodiment, there is provided a use of laminarin or a composition comprising laminarin for improving yield, disease management and post-harvest quality of a crop, a plant or an agricultural produce.

In an embodiment, there is provided a use of a combination of laminarin or a composition comprising laminarin and an agrochemically active agent for improving yield, disease management and post-harvest quality of a crop, a plant or an agricultural produce. The agrochemically active agent is a fungicide.

The “agricultural produce” refers to crops, cereals, legumes, fruits, vegetables and cut flowers. The term may refer to a standing crop, a pre-harvest crop or a post-harvest crop. It also refers to the harvested product of a crop or a plant. The term refers to any product of agriculture. An important advantage of the present invention is that when the laminarin is applied to an agriculture produce, it improves the quality of the agriculture produce, unexpectedly.

Examples of agricultural produce which can be treated successfully with laminarin within the framework of the use according to the invention are selected from the group comprising, but not limited to, crops, cereals, legumes, fruits, vegetables and cut flowers.

Examples of the crops on which the present compositions may be used include but are not limited to corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as strawberry, blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In a preferred embodiment, agricultural produce which can be treated successfully with laminarin within the framework of the use according to the invention are selected from the group comprising grape, strawberry, onion, apple and lettuce.

The active ingredients and compositions according to the present invention can prevent disadvantageous effects such as decay, discoloration or mold.

In an embodiment, the active ingredients and compositions according to the present invention are particularly effective for disease management and control in pre-harvest or post-harvest stage. The active ingredients and compositions according to the present invention are particularly effective against powdery mildews; rusts; leafspot species; early blights and molds; bunch rots; especially against Septoria, Puccinia, Erysiphe, Pyrenophora and Tapesia in cereals; Phakopsora in soybeans; Hemileia in coffee; Phragmidium in roses; Alternaria in potatoes, tomatoes and cucurbits; Sclerotinia in turf, vegetables, sunflower and oil seed rape; black rot, red fire, powdery mildew, grey mold and dead arm disease in vine; Botrytis cinerea in fruits, such as strawberries and grapes; Monilinia spp. in fruits and Penicillium spp. in fruits; blight caused by Stemphylium in onion. The active ingredients and compositions according to the present invention are furthermore particularly effective against seedborne and soilborne diseases, such as Alternaria spp., Ascochyta spp., Botrytis cinerea, Cercospora spp., Claviceps purpurea, Cochliobolus sativus, Colletotrichum spp., Epicoccum spp., Fusarium graminearum, Fusarium moniliforme, Fusarium oxysporum, Fusarium proliferatum, Fusarium solani, Fusarium subglutinans, Gaumannomyces graminis, Helminthosporium spp., Microdochium nivale, Phoma spp., Pyrenophora graminea, Pyricularia oryzae, Rhizoctonia solani, Rhizoctonia cerealis, Sclerotinia spp., Septoria spp., Sphacelotheca reilliana, Stemphylium spp., Tilletia spp., Typhula incarnata, Urocystis occulta, Ustilago spp., Uncinula necator or Verticillium spp.; in particular against pathogens of cereals, such as wheat, barley, rye or oats; maize; rice; cotton; soybean; turf; sugarbeet; oil seed rape; potatoes; pulse crops, such as peas, lentils or chickpea; and sunflower.

The active ingredients and compositions according to the present invention are furthermore particularly effective against post-harvest diseases such as Botrytis cinerea, Colletotrichum musae, Curvularia lunata, Fusarium semitecum, Geotrichum candidum, Monilinia fructicola, Monilinia fructigena, Monilinia laxa, Mucor piriformis, Penicilium italicum, Penicilium solitum, Uncinula necator, Penicillium digitatum or Penicillium expansum in particular against pathogens of fruits, such as pomefruits, for example apples and pears, stone fruits, for example peaches and plums, citrus, melons, papaya, kiwi, grapes, mango, berries, for example strawberries, avocados, pomegranates and bananas, and nuts. In an embodiment, contacting a plant, a crop or an agricultural produce with laminarin or a composition comprising laminarin, optionally in combination with an additional agrochemically active agent results in at least one of the following effects in the plant, the crop or the agricultural produce:
i) increase in the yield of the plant, the crop or the agricultural produce;
ii) increased pre-harvest disease management and control of the plant, the crop or the agricultural produce;
iii) increased post-harvest weight, shelf-life and/or vigor of agricultural produce;
iv) decreased post-harvest disease incidence and pest severity;
v) decreased post-harvest degradation and weight losses of agricultural produce; and/or
vi) decreased post-harvest nutrient loss; and/or
vii) increased nutrient content or post-harvest nutrient content.

In an embodiment, contacting a plant, a crop or an agricultural produce with laminarin or a composition comprising laminarin, optionally in combination with an additional agrochemically active agent comprises attaining atleast one of the following attributes in the crop, the plant or the agricultural produce:
i) increase in the yield of agricultural produce;
ii) control of fungal diseases such as downy mildew, gray mold, blight, powdery mildew;
iii) increased post-harvest vigor and shelf-life of agricultural produce;
iv) increased BRIX value of agricultural produce;
v) increased contents of nutrients such as sugar content, recoverable sugar;
vi) decreased post-harvest disease such as bunch rot, downy mildew, gray mold, blight, powdery mildew; and/or
vii) decreased post-harvest weight loss such as weight loss in bunch weight; sugar lost to molasses.

In an embodiment, the methods, combinations, and the compositions of the present invention are used for increasing the yield of a plant, a crop, or an agricultural produce. Preferably, the methods, combinations and the compositions of the present invention are used for increasing the yield of strawberry, grape, and onion.

In an embodiment, the methods, combinations, and the compositions of the present invention are used for increasing the post-harvest vigor of a plant, a crop, or an agricultural produce. Preferably, the methods, combinations and the compositions of the present invention are used for increasing the post-harvest vigor of lettuce, strawberry.

In an embodiment, the methods, combinations, and the compositions of the present invention are used for increasing the shelf-life of a plant, a crop, or an agricultural produce. Preferably, the methods, combinations and the compositions of the present invention are used for increasing the shelf-life of lettuce, strawberry, grape, and onion.

In an embodiment, the methods, combinations, and the compositions of the present invention are used for control of downy mildew in a plant, a crop, or an agricultural produce. Preferably, the methods, combinations and the compositions of the present invention are used for control of downy mildew in lettuce.

In an embodiment, the methods, combinations, and the compositions of the present invention are used for control of gray mold in a plant, a crop, or an agricultural produce. Preferably, the methods, combinations and the compositions of the present invention are used for control of gray mold in strawberry.

In an embodiment, the methods, combinations, and the compositions of the present invention are used for control of post-harvest bunch rot in a plant, a crop, or an agricultural produce. Preferably, the methods, combinations and the compositions of the present invention are used for control of post-harvest bunch rot in grape.

In an embodiment, the methods, combinations, and the compositions of the present invention are used for control of post-harvest weight loss in a plant, a crop, or an agricultural produce. Preferably, the methods, combinations and the compositions of the present invention are used for control of post-harvest weight loss in grape.

In an embodiment, the methods, combinations, and the compositions of the present invention are used for increase in post-harvest weight of a plant, a crop, or an agricultural produce. Preferably, the methods, combinations and the compositions of the present invention are used for increase in post-harvest weight of grape.

In an embodiment, the methods, combinations, and the compositions of the present invention are used for increase in BRIX value of a plant, a crop, or an agricultural produce. Preferably, the methods, combinations and the compositions of the present invention are used for increase in BRIX value of grape.

In an embodiment, the methods, combinations, and the compositions of the present invention are used for control of powdery mildew in a plant, a crop, or an agricultural produce. Preferably, the methods, combinations and the compositions of the present invention are used for control of powdery mildew in grape.

In an embodiment, the methods, combinations, and the compositions of the present invention are used for control of blight in a plant, a crop, or an agricultural produce. Preferably, the methods, combinations and the compositions of the present invention are used for control of blight in onion.

In an embodiment, the methods, combinations, and the compositions of the present invention are used for increase in post-harvest nutrient content of a plant, a crop, or an agricultural produce. The nutrient may be selected from sugars, proteins, amino acids, fatty acids, lipids, antioxidants, phenolics, vitamins and minerals. Preferably, the methods, combinations and the compositions of the present invention are used for increase in post-harvest sugar content of sugarbeet.

In an embodiment, the methods, combinations, and the compositions of the present invention are used for increase in recoverable nutrient content of a plant, a crop, or an agricultural produce. The nutrient may be selected from sugars, proteins, amino acids, fatty acids, lipids, antioxidants, phenolics, vitamins and minerals. Preferably, the methods, combinations and the compositions of the present invention are used for increase in recoverable sugar content of sugarbeet.

In an embodiment, the methods, combinations, and the compositions of the present invention are used for decreasing nutrient losses of a plant, a crop, or an agricultural produce during processing stages. The nutrient may be selected from sugars, proteins, amino acids, fatty acids, lipids, antioxidants, phenolics, vitamins and minerals. Preferably, the methods, combinations and the compositions of the present invention are used for decreasing sugar lost from sugarbeets to molasses.

As used, here above, the w/w refer to the weight by weight of the composition in grams.

While the foregoing written description of the invention enables one of ordinary skill to make and use what is considered presently to be the best mode thereof, those of ordinary skill will understand and appreciate the existence of variations, its combinations, and equivalents of the specific embodiment, method, and examples herein. The invention should therefore not be limited by the above-described embodiment, method, and examples, but by all embodiments and methods within the scope and spirit of the invention. Also, it should be understood that the use of ranges of numbers expressly includes any possible sub-domains and any other individual numeric values included in this range, and any numeric values in these ranges or sub domains, together with any fractions of the said numeric values or said whole numbers within these ranges, unless the context expressly indicated otherwise. This applies in all circumstances to all number ranges and in any context throughout this application. For example, a range of numbers from 10 to 80% includes 15 to 75%, 20-70%, 25-65%, 30-50% and so on.

### EXAMPLES

An experiment was conducted on lettuce, onion, strawberry and grape crop using laminarin as standalone and in combination with additional agrochemically active agents.

### Example 1: Effect of Laminarin on Post-Harvest Vigor of Lettuce

### Trial Treatment 1:

Laminarin (45 g/L) was applied standalone, in comparison with a combination with treatments of cyazofamid 400 g/L and mandipropamide 250 g/L on lettuce. The experiments were conducted in two different locations. The experiments included four applications of cyazofamid and mandipropamide in all and four applications of laminarin. The observations for efficacy (% control against downy mildew (Bremia lactucae)) and post-harvest vigor are recorded in the table given below:

TABLE 1
% Control against downy mildew (Bremia lactucae) in lettuce

| Treatment | Kg or L/ha | g.a.i/ha | Application* | % Control |
|---|---|---|---|---|
| Untreated Check | — | — | — | 0 |
| Cyazofamid + Mandipropamide | 0.25 + 0.6 | 100 + 150 | AC + BD | 67.5 |
| (400 + 250) | | | | |
| Laminarin (45) | 2.0 | 90 | ABCD | 72.2 |

*A = 1st application (7 days after transplanting); B = 2nd application; C = 3rd application; D = 4th application. Interval of application = 7 days

TABLE 2
Post-harvest vigor (%) in lettuce

| | | | | % Vigor | | | |
|---|---|---|---|---|---|---|---|
| | Kg or | g.a.i/ | Appli- | 0 | 3 | 5 | 7 |
| Treatment | L/ha | ha | cation* | DAH | DAH | DAH | DAH |
| Untreated Check | — | — | — | 100 | 81 | 19.7 | 2.6 |
| Cyazofamid + | 0.25 + | 100 + | AC + | 100 | 96.7 | 49.4 | 37.5 |
| Mandipropamide | 0.6 | 150 | BD | | | | |
| (400 + 250) | | | | | | | |
| Laminarin (45) | 2.0 | 90 | ABCD | 100 | 100 | 94.4 | 91.4 |

*A = 1 st application (7 days after transplanting); B = 2 nd application; C = 3 rd application; D = 4 th application Interval of application = 7 days
DAH = Days after harvest

### Trial Treatment 2:

Laminarin (45 g/L) was applied in combination with treatments of cyazofamid 400 g/L and mandipropamide 250 g/L on lettuce and Cyazofamid+Mandipropamide (400+250) treatment was used as reference. The experiments were conducted in two different locations. The number of applications for the treatments were halved as compared to the number of applications in Tables 1 & 2. The observations for efficacy (% control against downy mildew) and post-harvest vigor are recorded in the table given below:

TABLE 3
% Control against downy mildew (Bremia lactucae) in lettuce

| Treatment | Kg or L/ha | g.a.i/ha | Application* | % Control |
|---|---|---|---|---|
| Untreated Check | — | — | — | 0 |
| Cyazofamid + Mandipropamide | 0.25 + 0.6 | 100 + 150 | C + B | 61.8 |
| (400 + 250) | | | | |
| Cyazofamid + Mandipropamide + | 0.25 + 0.6 + | 100 + 150 + 90 | C + B + AD | 66.8 |
| Laminarin (400 + 250 + 45) | 2.0 | | | |

*A = 1 st application (7 days after transplanting); B = 2 nd application; C = 3 rd application; D = 4 th application
Interval of application = 7 days

TABLE 4
Post-harvest vigor (%) in lettuce

| | | | | % Vigor | | | |
|---|---|---|---|---|---|---|---|
| | Kg or | | | 0 | 3 | 5 | 7 |
| Treatment | L/ha | g.a.i/ha | Application* | DAH | DAH | DAH | DAH |
| Untreated Check | — | — | — | 100 | 81 | 19.7 | 2.6 |
| Cyazofamid + | 0.25 + 0.6 | 100 + 150 | C + B | 100 | 87.1 | 27.3 | 11.7 |
| Mandipropamide (400 + | | | | | | | |
| 250) | | | | | | | |
| Cyazofamid + | 0.25 + 0.6 + | 100 + 150 + | C + B + AD | 100 | 96.7 | 87.7 | 87.9 |
| Mandipropamide + | 2.0 | 90 | | | | | |
| Laminarin (400 + | | | | | | | |
| 250 + 45) | | | | | | | |

*A = 1 st application (7 days after transplanting); B = 2 nd application; C = 3 rd application; D = 4 th application
Interval of application = 7 days
DAH = Days after harvest

It can be observed from the above example 1 that for lettuce, laminarin standalone exerted better control against downy mildew (Bremia lactucae) and demonstrated better post-harvest vigor as compared to Cyazofamid+Mandipropamide (400+250). The combination Cyazofamid+Mandipropamide+Laminarin (400+250+45) demonstrated increased control against downy mildew and demonstrated better post-harvest vigor than Cyazofamid+Mandipropamide (400+250). From the above example, it is evident that better fungal control and post-harvest vigor can be achieved with less or no chemical pesticide usage and lesser applications of chemical pesticides to preserve freshness of lettuce for a longer time (upto 7 days or more).

### Example 2: Effect of Laminarin on Gray Mold of Strawberry, Yield and Post-Harvest Vigor of Strawberry Crop

### Trial Treatment 1:

Efficacy of laminarin SL (45 g/L) standalone, in comparison with and within chemical combination with boscalid WG (500 g/L) and pyrimethanil SC (300 g/L) was evaluated for control of gray mold caused by Botrytis cinerea in strawberry fruit. The treatments were also evaluated for yield and post-harvest vigor of strawberry.

### Spray Volume: 1000 L/Ha

Five applications A, B, C, D and E were performed with an interval of 7 days with the 1st application A in pre-flowering, 2nd application at 7 DA-A; 3rd application to 7 DA-B; 4th application at 7 DA-C and 5th application at 7 DA-D. Disease severity was evaluated before each spray and 7, 14 and 21 days after last spray. Phytotoxicity (0 to 100%) was evaluated before each spray and 7, 14 and 21 days after last spray. Yield was evaluated as Kg/ha and post-harvest vigor (%) was evaluated at 1, 3, 5, 7, 10, 15 and 20 days after harvest.

TABLE 5
% Control against B. cinerea (gray mold) in strawberries

| Treatment | Kg or L/ha | g.a.i/ha | Application | % Control |
|---|---|---|---|---|
| Untreated Check | — | — | — | 0 |
| Boscalid + | 0.8 + 1.2 | 400 + 360 | ACE + BD | 65 |
| Pyrimethanil | | | | |
| (500 + 300) | | | | |
| Laminarin (45) | 2.0 | 90 | ABCDE | 79 |

TABLE 6
Post-harvest vigor (%) in strawberries

| | | | | % Vigor | | | | | | |
|---|---|---|---|---|---|---|---|---|---|---|
| | Kg or | g.a.i/ | | 1 | 3 | 5 | 7 | 10 | 15 | 20 |
| Treatment | L/ha | ha | Application | DAH | DAH | DAH | DAH | DAH | DAH | DAH |
| Untreated Check | — | — | — | 100 | 97.5 | 83.1 | 75.6 | 55.0 | 18.8 | 0 |
| Boscalid + | 0.8 + | 400 + | ACE + | 100 | 95 | 86.9 | 76.3 | 58.1 | 36.9 | 17.5 |
| Pyrimethanil | 1.2 | 360 | BD | | | | | | | |
| (500 + 300) | | | | | | | | | | |
| Laminarin (45) | 2.0 | 90 | ABCDE | 100 | 100 | 99.4 | 94.4 | 81.9 | 48.4 | 28.1 |

DAH = Days after harvest

TABLE 7
Yield of strawberries in Kg/ha

| Treatment | Kg or L/ha | g.a.i/ha | Application | Yield Kg/ha |
|---|---|---|---|---|
| Untreated Check | — | — | — | 19405 |
| Boscalid + Pyrimethanil | 0.8 + 1.2 | 400 + 360 | ACE + BD | 19092 |
| (500 + 300) | | | | |
| Boscalid + Pyrimethanil + | 0.8 + 1.2 + 2.0 | 400 + 360 + 90 | ACE + BD + | 24274 |
| Laminarin (500 + 300 + 45) | | | ABCDE | |
| Laminarin (45) | 2.0 | 90 | ABCDE | 20860 |

### Trial Treatment 2:

Laminarin (45 g/L) was applied in combination with treatments of Boscalid+Pyrimethanil (500+300) on strawberry and Boscalid+Pyrimethanil (500+300) treatment was used as reference. The experiments were conducted in two different locations. The number of applications for the treatments were reduced as compared to the number of applications in Tables 5, 6 and 7. The observations for efficacy (% control against gray mold) and post-harvest vigor are recorded in the table given below:

TABLE 8
% Control against B. cinerea (gray mold) in strawberries

| Treatment | Kg or L/ha | g.a.i/ha | Application | % Control |
|---|---|---|---|---|
| Untreated Check | — | — | — | 0 |
| Boscalid + Pyrimethanil | 0.8 + 1.2 | 400 + 360 | CE + D | 57 |
| (500 + 300) | | | | |
| Boscalid + Pyrimethanil + | 0.8 + 1.2 + 2.0 | 400 + 360 + 90 | CE + D + AB | 71 |
| Laminarin (500 + 300 + 45) | | | | |

TABLE 9
Post-harvest vigor (%) in strawberries

| | | | | % Vigor | | | | | | |
|---|---|---|---|---|---|---|---|---|---|---|
| | Kg or | g.a.i/ | | 1 | 3 | 5 | 7 | 10 | 15 | 20 |
| Treatment | L/ha | ha | Application | DAH | DAH | DAH | DAH | DAH | DAH | DAH |
| Untreated Check | — | — | — | 100 | 97.5 | 83.1 | 75.6 | 55.0 | 18.8 | 0 |
| Boscalid + | 0.8 + | 400 + | CE + D | 100 | 97.5 | 86.3 | 75 | 60.6 | 28.1 | 5 |
| Pyrimethanil | 1.2 | 360 | | | | | | | | |
| (500 + 300) | | | | | | | | | | |
| Boscalid + | 0.8 + | 400 + | CE + | 100 | 95.6 | 85.6 | 72.5 | 55 | 42.5 | 35 |
| Pyrimethanil + | 1.2 + | 360 + | D + AB | | | | | | | |
| Laminarin (500 + | 2.0 | 90 | | | | | | | | |
| 300 + 45) | | | | | | | | | | |

DAH = Days after harvest

TABLE 10
Yield of strawberries in Kg/ha

| Treatment | Kg or L/ha | g.a.i/ha | Application | Yield Kg/ha |
|---|---|---|---|---|
| Untreated Check | — | — | — | 19405 |
| Boscalid + Pyrimethanil | 0.8 + 1.2 | 400 + 360 | CE + D | 17085 |
| (500 + 300) | | | | |
| Boscalid + Pyrimethanil + | 0.8 + 1.2 + 2.0 | 400 + 360 + 90 | CE + D + AB | 24131 |
| Laminarin (500 + 300 + 45) | | | | |

It can be observed from the above example 2 that for strawberries, laminarin standalone exerted better control against gray mold and demonstrated better post-harvest vigor as compared to Boscalid+Pyrimethanil (500+300). The combination Boscalid+Pyrimethanil+Laminarin (500+300+45) demonstrated increased control against gray mold and demonstrated better post-harvest vigor than Boscalid+Pyrimethanil (500+300). From the above example, it is evident that better fungal control and post-harvest vigor can be achieved with less or no chemical usage and lesser applications of chemical pesticides to preserve freshness of lettuce for a longer time (upto 7 days or more) when laminarin is used standalone or in combination with additional agrochemical treatments.

In terms of yield, when laminarin was added to the treatment of Boscalid+Pyrimethanil (500+300), higher yields were observed in the strawberry crop as compared to the treatments without laminarin. Moreover, compared to standalone treatments of laminarin and additional agrochemicals, it can be noted that higher yields were obtained when laminarin and agrochemical treatments were combined.

### Example 3: Effect of Laminarin on Control of Post-Harvest BRIX Values, Post-Harvest Bunch Rot and Weight Loss in Grape

### Trial Treatment 1:

Efficacy of laminarin SL (45 g/L) standalone, in comparison with and within combination with treatments of Boscalid & Kresoxim premix (300 g/L), Azoxystrobin & Difenoconazole premix (325 g/L) and Metiram & Pyraclostrobin premix (600 g/L) was evaluated for incidence of post-harvest bunch rot (%), post-harvest weight loss and post-harvest BRIX values in grape.

Spray Volume: 800 L/ha

$$Weight loss \% = \frac{\begin{matrix}( Weight of bunch ( g / bunch ) at 0 DAH - \\ Weight of bunch ( g / bunch ) at 21 DAH )\end{matrix}}{Weight of bunch ( g / bunch ) at 0 DAT}$$

Degrees Brix or °Brix (Brix) is a measure of the total soluble solids (TSS) present in the fruit. TSS is mainly made up of sugars but also includes other compounds. The total soluble solids are made up of
Sugars, which can be monosaccharides, disaccharides, or oligosaccharides, such as sucrose, fructose, etc.
Organic acids, such as citric, malic, tartaric acids etc.
Soluble amino acids, but not proteins as they are not soluble.
Other miscellaneous compounds, such as fat, minerals, alcohol, flavonoids (Vitamin C and Vitamin A), etc.

Brix can be used as a measure of maturity, flavour, and level of sweetness in fruits and vegetables to help in fixing the time of harvest, sales, and processing.

TABLE 11
Incidence of bunch rot (%) after harvest in grapes

| | | | | Incidence of bunch rot (%) | | | |
|---|---|---|---|---|---|---|---|
| | Kg or | g.a.i/ | | 0 | 5 | 10 | 21 |
| Treatment | L/ha | ha | Application* | DAH | DAH | DAH | DAH |
| Untreated Check | — | — | — | 0 | 0 | 2.1 | 4.5 |
| Boscalid & Kresoxim | 0.5 + 0.5 + | 150 + 163 + | AD + BE + CF | 0 | 0 | 3.8 | 3.3 |
| (300) | 2.0 | 1200 | | | | | |
| Azoxystrobin & | | | | | | | |
| Difenoconazole (325) | | | | | | | |
| Metiram & | | | | | | | |
| Pyraclostrobin (600) | | | | | | | |
| Laminarin (45) | 2.0 | 90 | ABCDEF | 0 | 0 | 0.97 | 1.3 |

*A = 1st application (clearly visible inflorescences); B = 2nd application; C = 3rd application; D = 4th application; E = 5th application; F = 6th application. Interval of application = 7 days.
DAH = Days after harvest

TABLE 12
Post harvest weight (g/bunch) and weight loss (%) in grapes

| | | | | Weight (g/bunch) | | | | Weight |
|---|---|---|---|---|---|---|---|---|
| | Kg or | g.a.i/ | | 0 | 5 | 10 | 21 | loss |
| Treatment | L/ha | ha | Application* | DAH | DAH | DAH | DAH | (%) |
| Untreated Check | — | — | — | 600 | 598.7 | 591.2 | 575.5 | 4.1 |
| Boscalid & | 0.5 + | 150 + | AD + | 771.2 | 771.2 | 763.7 | 731.2 | 5.2 |
| Kresoxim (300) | 0.5 + | 163 + | BE + | | | | | |
| Azoxystrobin & | 2.0 | 1200 | CF | | | | | |
| Difenoconazole | | | | | | | | |
| (325) | | | | | | | | |
| Metiram & | | | | | | | | |
| Pyraclostrobin | | | | | | | | |
| (600) | | | | | | | | |
| Laminarin (45) | 2.0 | 90 | ABCDEF | 780 | 777.5 | 772.5 | 750 | 3.8 |

*A = 1st application (clearly visible inflorescences); B = 2nd application; C = 3rd application; D = 4th application; E = 5th application; F = 6th application. Interval of application = 7 days.
DAH = Days after harvest

### Trial Treatment 2:

Laminarin (45 g/L) was applied in combination with treatments of Boscalid & Kresoxim premix (300 g/L), Azoxystrobin & Difenoconazole premix (325 g/L) and Metiram & Pyraclostrobin premix (600 g/L) in grape. Boscalid & Kresoxim premix (300 g/L), Azoxystrobin & Difenoconazole premix (325 g/L) and Metiram & Pyraclostrobin premix (600 g/L) treatment was used as reference. The number of applications for the treatments were halved as compared to the number of applications in Tables 11 & 12. The observations after the treatments were applied-% incidence of bunch rot and post-harvest weight loss of bunch (g/bunch and %) are recorded in the table given below:

TABLE 13
Incidence of bunch rot (%) after harvest in grapes

| | | | | Incidence of bunch rot (%) | | | |
|---|---|---|---|---|---|---|---|
| | Kg or | g.a.i/ | | 0 | 5 | 10 | 21 |
| Treatment | L/ha | ha | Application* | DAH | DAH | DAH | DAH |
| Untreated Check | — | — | — | 0 | 0 | 2.1 | 4.5 |
| Boscalid & Kresoxim | 0.5 + 0.5 + | 150 + 163 + | D + B + | 0 | 0 | 2.5 | 1.6 |
| (300) | 2.0 + 2.0 | 1200 + 90 | F + ACE | | | | |
| Azoxystrobin & | | | | | | | |
| Difenoconazole (325) | | | | | | | |
| Metiram & | | | | | | | |
| Pyraclostrobin (600) + | | | | | | | |
| Laminarin (45) | | | | | | | |

*A = 1st application (clearly visible inflorescences); B = 2nd application; C = 3rd application; D = 4th application; E = 5th application; F = 6th application. Interval of application = 7 days.
DAH = Days after harvest

TABLE 14
Post harvest weight (g/bunch) and weight loss (%) in grapes

| | | | | Weight (g/bunch) | | | | Weight |
|---|---|---|---|---|---|---|---|---|
| | Kg or | g.a.i/ | | 0 | 5 | 10 | 21 | loss |
| Treatment | L/ha | ha | Application* | DAH | DAH | DAH | DAH | (%) |
| Boscalid & | 0.5 + | 150 + | D + B + F | 642.5 | 640 | 633.7 | 610 | 5.1 |
| Kresoxim (300) | 0.5 + | 163 + | | | | | | |
| Azoxystrobin & | 2.0 | 1200 | | | | | | |
| Difenoconazole | | | | | | | | |
| (325) | | | | | | | | |
| Metiram & | | | | | | | | |
| Pyraclostrobin | | | | | | | | |
| (600) | | | | | | | | |
| Boscalid & | 0.5 + | 150 + | D + B + | 687.5 | 687.5 | 681.2 | 656.2 | 4.6 |
| Kresoxim (300) | 0.5 + | 163 + | F + ACE | | | | | |
| Azoxystrobin & | 2.0 + | 1200 + | | | | | | |
| Difenoconazole | 2.0 | 90 | | | | | | |
| (325) | | | | | | | | |
| Metiram & | | | | | | | | |
| Pyraclostrobin | | | | | | | | |
| (600) + Laminarin | | | | | | | | |
| (45) | | | | | | | | |

*A = 1st application (clearly visible inflorescences); B = 2nd application; C = 3rd application; D = 4th application; E = 5th application; F = 6th application. Interval of application = 7 days.
DAH = Days after harvest

TABLE 15
BRIX (%) after harvest in grapes

| | Kg or | | | |
|---|---|---|---|---|
| Treatment | L/ha | g.a.i/ha | Application* | BRIX (%) |
| Untreated Check | — | — | — | 14.2 |
| Boscalid & Kresoxim (300) | 0.5 + 0.5 + | 150 + 163 + | AD + BE + CF | 14.3 |
| Azoxystrobin & Difenoconazole (325) | 2.0 | 1200 | | |
| Metiram & Pyraclostrobin (600) | | | | |
| Laminarin (45) | 2.0 | 90 | ABCDEF | 15.7 |

*A = 1st application (clearly visible inflorescences); B = 2nd application; C = 3rd application; D = 4th application; E = 5th application; F = 6th application. Interval of application = 7 days.
DAT = Days after treatment

From example 3, it is observed that addition of laminarin within fungicides program and standalone promoted less bunch rot and weight losses than other treatments, since the beginning to the end. Additionally, it is also observed that treatments with laminarin within fungicides program and standalone also reduced the bunch weight losses in grapes 21 days after the harvest.

Laminarin standalone promoted increased BRIX values in the harvested product.

### Example 4: Effect of Laminarin on Pre-Harvest Gray Mold Control, Post-Harvest Gray Mold Control and Yield in Grape

### Trial Treatment 1:

Efficacy of laminarin SL (45 g/L) standalone, in comparison with and within combination with treatments of Procimidone (500 g/L) (750 gai/ha)+Pyrimethanil (300 g/L) (600 gai/ha) was evaluated for severity of Botrytis cinerea control (%), yield (Kg/ha), pest severity (%) and control (%) of Botrytis cinerea upto 7 days after harvest in grape. 6 Applications (ABCDEF) were carried out within 7 days, the first application starting at stage BBCH 71 (Young fruits begin to swell, remains of flowers lost).

### Spray Volume: 800 L/Ha

Pre-harvest severity of the disease was evaluated in at least 20 leaves/plot (same size and age) in the central area of each plot. Prior evaluations were performed before the first application. Disease severity and control was evaluated at 5 days after each application and at 7 and 14 days after the last application (F).

Post-harvest disease severity was evaluated at 1,3,5 and 7 days after harvest.

TABLE 16
% control of gray mold in grape based
on disease severity in leaves.

| Treatments (dose)/Application rate (Application time) | % Control |
|---|---|
| Untreated | 0.0 |
| Procimidone (750 gai/ha) 1.5 Kg/ha (ACE)/Pyrimethanil | 62.0 |
| (600 gai/ha) 2.0 L/ha (BDF) | |
| Procimidone (750 gai/ha) 1.5 Kg/ha (ACE)/Pyrimethanil | 78.0 |
| (600 gai/ha) 2.0 L/ha (BDF)/ | |
| Laminarin SL (45 g/L) (90 gai/ha) 2.0 L/ha (ABCDEF) | |
| Laminarin SL (45 g/L) (90 gai/ha) 2.0 L/ha (ABCDEF) | 42.0 |

TABLE 17
Yield and yield increase in grape

| Treatments (dose)/Application | Yield | Yield increase |
|---|---|---|
| rate (Application time) | (Kg/ha) | (Kg/ha) |
| Untreated | 31625.0 | 0.0 |
| Procimidone (750 gai/ha) 1.5 Kg/ha (ACE)/ | 36683.0 | 5058.0 |
| Pyrimethanil (600 gai/ha) 2.0 L/ha (BDF) | | |
| Procimidone (750 gai/ha) 1.5 Kg/ha (ACE)/ | 40497.0 | 8872.0 |
| Pyrimethanil (600 gai/ha) 2.0 L/ha (BDF)/ | | |
| Laminarin SL (45 g/L) (90 gai/ha) | | |
| 2.0 L/ha (ABCDEF) | | |
| Laminarin SL (45 g/L) (90 gai/ha) | 33058.0 | 1433.0 |
| 2.0 L/ha (ABCDEF) | | |

Yield increase in grape is calculated as difference in the yield of treated plants and untreated plants.

TABLE 18
Post harvest disease severity (1, 3, 5, 7 DAH) and % control of gray mold in grape

| Treatments (dose)/Application | Disease severity % | | | | Average |
|---|---|---|---|---|---|
| rate (Application time) | 1 DAH | 3 DAH | 5 DAH | 7 DAH | % Control |
| Untreated | 6.3 | 17.3 | 26.5 | 33.8 | 0.0 |
| Procimidone (750 gai/ha) 1.5 Kg/ha (ACE)/ | 2.8 | 9.0 | 16.8 | 22.5 | 39 |
| Pyrimethanil (600 gai/ha) 2.0 L/ha (BDF) | | | | | |
| Procimidone (750 gai/ha) 1.5 Kg/ha (ACE)/ | 0.0 | 1.5 | 2.8 | 7.5 | 86 |
| Pyrimethanil (600 gai/ha) 2.0 L/ha (BDF)/ | | | | | |
| Laminarin SL (45 g/L) (90 gai/ha) 2.0 L/ha | | | | | |
| (ABCDEF) | | | | | |
| Laminarin SL (45 g/L) (90 gai/ha) 2.0 L/ha | 0.0 | 1.3 | 6.3 | 8.0 | 82 |
| (ABCDEF) | | | | | |

DAH = Days after harvest

### Trial Treatment 2:

Laminarin (45 g/L) was applied in combination with treatments of Procimidone (500 g/L) (750 gai/ha)+Pyrimethanil (300 g/L) (600 gai/ha) and Procimidone (500 g/L) (750 gai/ha)+Pyrimethanil (300 g/L) (600 gai/ha) was used as reference. The treatments were evaluated for severity of Botrytis cinerea control (%), yield (Kg/ha), pest severity (%) and control (%) of Botrytis cinerea upto 7 days after harvest in grape. Applications (ABCDEF) were carried out within 7 days, the first application starting at stage BBCH 71 (Young fruits begin to swell, remains of flowers lost). The number of applications were reduced as compared to tables 16, 17 and 18.

### Spray Volume: 800 L/ha

Pre-harvest severity of the disease was evaluated in at least 20 leaves/plot (same size and age) in the central area of each plot. Prior evaluations were performed before the first application. Disease severity and control was evaluated at 5 days after each application and at 7 and 14 days after the last application (F).

Post-harvest disease severity was evaluated at 1,3,5 and 7 days after harvest.

TABLE 19
% control of gray mold in grape based
on disease severity in leaves.

| Treatments (dose)/Application | |
|---|---|
| rate (Application time) | % Control |
| Untreated | 0.0 |
| Procimidone (750 gai/ha) 1.5 Kg/ha (CE)/ | 62.0 |
| Pyrimethanil (600 gai/ha) 2.0 L/ha (B) | |
| Procimidone (750 gai/ha) 1.5 Kg/ha (CE)/ | 71.0 |
| Pyrimethanil (600 gai/ha) 2.0 L/ha (B)/ | |
| Laminarin SL (45 g/L) (90 gai/ha) 2.0 L/ha (ADF) | |

TABLE 20
Yield and yield increase in grape

| | | Yield |
|---|---|---|
| Treatments (dose)/Application | Yield | increase |
| rate (Application time) | (Kg/ha) | (Kg/ha) |
| Untreated | 31625.0 | 0.0 |
| Procimidone (750 gai/ha) 1.5 Kg/ha (CE)/ | 40961.0 | 9336.0 |
| Pyrimethanil (600 gai/ha) 2.0 L/ha (B) | | |
| Procimidone (750 gai/ha) 1.5 Kg/ha (CE)/ | 43276.0 | 11651.0 |
| Pyrimethanil (600 gai/ha) 2.0 L/ha (B)/ | | |
| Laminarin SL (45 g/L) (90 gai/ha) | | |
| 2.0 L/ha (ADF) | | |

Yield increase in grape is calculated as difference in the yield of treated plants and untreated plants.

TABLE 21
Post harvest disease severity (1, 3, 5, 7 DAH) and % control of gray mold in grape

| Treatments (dose)/Application | Disease severity % | | | | Average % |
|---|---|---|---|---|---|
| rate (Application time) | 1 DAH | 3 DAH | 5 DAH | 7 DAH | Control |
| Untreated | 6.3 | 17.3 | 26.5 | 33.8 | 0.0 |
| Procimidone (750 gai/ha) 1.5 Kg/ha (CE)/ | 3.0 | 12.0 | 22.3 | 26.3 | 24 |
| Pyrimethanil (600 gai/ha) 2.0 L/ha (B) | | | | | |
| Procimidone (750 gai/ha) 1.5 Kg/ha (CE)/ | 0.5 | 6.3 | 15.0 | 18.0 | 53 |
| Pyrimethanil (600 gai/ha) 2.0 L/ha (B)/ | | | | | |
| Laminarin SL (45 g/L) (90 gai/ha) 2.0 L/ha | | | | | |
| (ADF) | | | | | |

DAH = Days after harvest

From example 4, it is observed that addition of laminarin within fungicides program and standalone laminarin promoted better control of gray mold, before and after harvest. Addition of laminarin to fungicides program promoted increased yield compared to individual treatments.

### Example 5: Effect of Laminarin on Yield and Blight Disease of Onion Crop

### Trial 1:

Efficacy of laminarin SL (45 g/L) standalone or within chemical combination with mancozeb WG (750 g/L) and difenoconazole WG (750 g/L) was evaluated for yield (Kg/ha) in onion crop and control of onion blight.

### Spray Volume: 1000 L/Ha

Six applications A, B, C, D, E and F were performed with an interval of 7 days with the 1^{st} application being 25 days after transplanting, 2nd application at 7 DA-A; 3rd application to 7 DA-B; 4th application at 7 DA-C; 5th application at 7 DA-D and 6th application at 7 DA-E. Phytotoxicity (0 to 100%) was evaluated before each spray and 7, 14 and 21 days after last spray. Control of onion blight was recorded as % control. Yield was evaluated as Kg/ha.

TABLE 22
Yield of onion in Kg/ha

| Treatment | Kg or L/ha | g.a.i/ha | Application* | Yield Kg/ha |
|---|---|---|---|---|
| Untreated Check | — | — | — | 35188 |
| Mancozeb + Difenoconazole | 3.0 + 0.6 | 2250 + 150 | ACE + BDF | 39563 |
| (750 + 750) | | | | |
| Mancozeb + Difenoconazole + | 3.0 + 0.6 + | 2250 + 150 + | ACE + BDF + | 42375 |
| Laminarin (750 + 750 + 45) | 2.0 | 90 | ABCDEF | |
| Laminarin (45) | 2.0 | 90 | ABCDEF | 39219 |

TABLE 22
% Control of onion blight (Stemphylium spp)

| | | | | % Control of |
|---|---|---|---|---|
| Treatment | Kg or L/ha | g.a.i/ha | Application* | Stemphylium |
| Untreated Check | — | — | — | 0 |
| Mancozeb + Difenoconazole | 3.0 + 0.6 | 2250 + 150 | ACE + BDF | 56 |
| (750 + 750) | | | | |
| Mancozeb + Difenoconazole + | 3.0 + 0.6 + | 2250 + 150 + | ACE + BDF + | 58 |
| Laminarin (750 + 750 + 45) | 2.0 | 90 | ABCDEF | |

From the above observations, it is evident that application of laminarin standalone and in combination with other fungicidal treatments increased the yield of onion crop. Also, no phytotoxicity was observed from the treatments.

### Example 6: Effect of Laminarin on Sugar Content of Sugar Beet Crop

### Trial 1:

Efficacy of laminarin on post-harvest content of sugar beet was evaluated. Foliar application of laminarin was done on sugar beet crop at 4 weeks before harvest. Laminarin was applied at a rate of 36 g ai/ha. Percent sugar and percent recoverable sugar was calculated for sugar beets after harvest at 0 days of storage, 45 days of storage and 90 days of storage. Percent change in sugar content during storage period was calculated with reference to the sugar content at 0 days of storage. Sugar losses to molasses were also calculated for the treated samples and untreated samples.

TABLE 23
Sugar beet percent sugar and percent change in sugar content during storage.

| | | | | % Increase in Sugar beet | |
|---|---|---|---|---|---|
| | | | | Percent Sugar (in comparison | |
| | Sugar beet Percent Sugar | | | with 0 days at storage) | |
| | 0 days in | 45 days in | 90 days in | at 45 | at 90 |
| Treatment | storage | storage | storage | days | days |
| Untreated | 17.1 | 19.6 | 24.18 | 2.5 | 7.08 |
| Laminarin applied | 15.2 | 18.9 | 25.12 | 3.7 | 9.92 |
| at 4-week pre-harvest | | | | | |

TABLE 24
Sugar beet percent recoverable sugar and percent change
in recoverable sugar content during storage.

| | | | | % Increase in Sugar beet | |
|---|---|---|---|---|---|
| | Sugar beet Percent Recoverable Sugar | | | Percent Recoverable Sugar | |
| | 0 days in | 45 days in | 90 days in | at 45 | at 90 |
| Treatment | storage | storage | storage | days | days |
| Untreated | 16 | 18.7 | 23.51 | 2.7 | 7.51 |
| Laminarin applied | 14.1 | 18 | 24.33 | 3.9 | 10.23 |
| at 4-week pre-harvest | | | | | |

### Trial 2:

Foliar application of laminarin was done on one plantation of sugar beet crop at 2 weeks and 4 weeks before harvest. Foliar application of laminarin was done on another plantation of sugar beet crop at 4 weeks before harvest. Laminarin was applied at a rate of 36 g ai/ha. Sugar lost to molasses was calculated after the harvest of sugar beets.

TABLE 25
Sugar lost to molasses after harvest of sugar beets.

| | % Sugar lost to |
|---|---|
| Treatment | molasses after harvest |
| Untreated | 1.15 |
| Laminarin applied at | 1.08 |
| 4-week pre-harvest | |
| Laminarin applied at | 1.06 |
| 2- & 4-week pre-harvest | |

From the above trials it is evident that laminarin when applied at pre-harvest, it reduces sugar loss to molasses which is a by-product obtained during sugar production.

### Example 7: Effect of Laminarin on Yield, Post-Harvest Disease Control, BRIX, Weight Loss of Grape

### Trial 1:

Efficacy of laminarin SL (45 g/L) within chemical combination with difenoconazole EC (250 g/L), boscalid+kresoxim-methyl SC (300 g/L) and triflumizole WP (300 g/L) was evaluated for % control of powdery mildew caused by Uncinula necator, post-harvest bunch weight, and yield (Kg/ha) in grape.

### Spray Volume: 800 L/Ha

10 applications A, B, C, D, E, F, G, H, I, J were performed with an interval of 3 days with the 1^{st} application being at inflorescence stage (BBCH 53). Severity of disease was evaluated in at least 20 leaves/plot, prior evaluation was performed before the first application, at 3 days after each application and at 7 and 10 days after the last application. Phytotoxicity (0 to 100%) was evaluated before each spray and at 3 days after each application. Post-harvest bunch weight was evaluated at 19 days after harvest. Control of powdery mildew was recorded as % control. Yield was evaluated as Kg/ha. Post-harvest bunch weight was recorded as g/bunch.

TABLE 26
% Control of powdery mildew (Uncinula necator) in grape

| | | | | % Control |
|---|---|---|---|---|
| | | | | of Uncinula |
| Treatment | Kg or L/ha | g.a.i/ha | Application* | necator |
| Untreated Check | — | — | — | 0 |
| Difenoconazole + | 0.072 + | 18 + | ADGJ | 92.3 |
| Boscalid + Kresoxim-methyl + | 0.5 + | 100 + 50 + | BEI | |
| Triflumizole | 0.48 | 144 | CFH | |
| Difenoconazole + | 0.072 + | 18 + | ADGJ | 99.1 |
| Boscalid + Kresoxim-methyl + | 0.5 + | 100 + 50 + | BEI | |
| Triflumizole + | 0.48 + | 144 + | CFH | |
| Laminarin | 2 | 90 | ACEGI | |

TABLE 27
Yield (Kg/ha) in grape

| | | | | Yield |
|---|---|---|---|---|
| Treatment | Kg or L/ha | g.a.i/ha | Application* | (Kg/ha) |
| Untreated Check | — | — | — | 15528.4 |
| Difenoconazole + | 0.072 + | 18 + | ADGJ | 27265.9 |
| Boscalid + Kresoxim-methyl + | 0.5 + | 100 + 50 + | BEI | |
| Triflumizole | 0.48 | 144 | CFH | |
| Difenoconazole + | 0.072 + | 18 + | ADGJ | 29928.5 |
| Boscalid + Kresoxim-methyl + | 0.5 + | 100 + 50 + | BEI | |
| Triflumizole + | 0.48 + | 144 + | CFH | |
| Laminarin | 2 | 90 | ACEGI | |

TABLE 28
Post-harvest bunch weight (g/bunch) in grape

| | | | | Post-harvest bunch |
|---|---|---|---|---|
| Treatment | Kg or L/ha | g.a.i/ha | Application* | weight (g/bunch) |
| Untreated Check | — | — | — | 412.3 |
| Difenoconazole + | 0.072 + | 18 + | ADGJ | 500.5 |
| Boscalid + Kresoxim-methyl + | 0.5 + | 100 + 50 + | BEI | |
| Triflumizole | 0.48 | 144 | CFH | |
| Difenoconazole + | 0.072 + | 18 + | ADGJ | 535.0 |
| Boscalid + Kresoxim-methyl + | 0.5 + | 100 + 50 + | BEI | |
| Triflumizole + | 0.48 + | 144 + | CFH | |
| Laminarin | 2 | 90 | ACEGI | |

### Trial 2:

Efficacy of laminarin SL (45 g/L) standalone or within chemical combination with potassium bicarbonate SP (820 g/L) was evaluated for % control of powdery mildew caused by Uncinula necator, and post-harvest bunch weight in grape.

### Spray Volume: 800 L/Ha

10 applications A, B, C, D, E, F, G, H, I, J were performed with an interval of 3 days with the 1^{st} application being at inflorescence stage (BBCH 53). Severity of disease was evaluated in at least 20 leaves/plot, prior evaluation was performed before the first application, at 3 days after each application and at 7 and 10 days after the last application. Phytotoxicity (0 to 100%) was evaluated before each spray and at 3 days after each application. Post-harvest bunch weight was evaluated at 19 days after harvest. Control of powdery mildew was recorded as % control. Post-harvest bunch weight was recorded as g/bunch.

TABLE 29
% Control of powdery mildew (Uncinula necator) in grape

| | | | | % Control |
|---|---|---|---|---|
| | | | | of Uncinula |
| Treatment | Kg or L/ha | g.a.i/ha | Application* | necator |
| Untreated Check | — | — | — | 0 |
| Potassium bicarbonate | 2 | 1640 | ABCDEFGHIJ | 67.7 |
| Laminarin | 2 | 90 | ABCDEFGHIJ | 68.9 |
| Potassium bicarbonate + | 2 + 2 | 1640 + 90 | ABCDEFGHIJ | 86.9 |
| Laminarin | | | ABCDEFGHIJ | |

TABLE 30
Post-harvest bunch weight (g/bunch) in grape

| | | | | Post-harvest bunch |
|---|---|---|---|---|
| Treatment | Kg or L/ha | g.a.i/ha | Application* | weight (g/bunch) |
| Untreated Check | — | — | — | 412.3 |
| Potassium bicarbonate | 2 | 1640 | ABCDEFGHIJ | 420.3 |
| Laminarin | 2 | 90 | ABCDEFGHIJ | 450.3 |
| Potassium bicarbonate + | 2 + 2 | 1640 + 90 | ABCDEFGHIJ | 462.8 |
| Laminarin | | | ABCDEFGHIJ | |

The present invention provides an advantage in terms of improving yield, disease management and post-harvest quality of the produce with less or no chemical treatments. Standalone laminarin was found to be effective in improving yield and disease management and post-harvest quality of the produce. Additionally, laminarin in combination with additional agrochemical treatments showed increased efficacy as compared to the additional agrochemical treatments.

1-50. (canceled)

51. A method for improving yield, disease management and post-harvest quality of a crop, a plant or an agricultural produce using laminarin or a composition comprising laminarin, wherein laminarin or a composition comprising laminarin is contacted with the crop, the plant or the agricultural produce at pre-harvest stage.

52. The method of claim 51, wherein the application rate of the laminarin ranges from 10-200 g.a.i/ha.

53. The method of claim 51, wherein said method comprises attaining at least one of the following attributes in the crop, the plant or the agricultural produce:
i) increase in the yield of the plant, the crop or the agricultural produce;
ii) increased pre-harvest disease management and control of the plant, the crop or the agricultural produce;
iii) increased post-harvest weight, shelf-life and/or vigor of agricultural produce;
iv) decreased post-harvest disease incidence and pest severity;
v) decreased post-harvest degradation and weight losses of agricultural produce; and/or
vi) decreased post-harvest nutrient loss; and/or
vii) increased nutrient content or post-harvest nutrient content.

54. The method of claim 51, wherein the agricultural produce is selected from crops, cereals, legumes, fruits, vegetables and cut flowers, preferably from lettuce, onion, sugarbeet, strawberry, apple, and grape.

55. The method of claim 51, wherein laminarin is applied alone or in combination with additional agrochemically active agents selected from a fungicide, an insecticide, an anti-sprout agent, a post-harvest agent, an algicide, a biological agent, a biostimulant, or a combination thereof.

56. The method of claim 55, wherein the fungicide is selected from cyazofamid, mandipropamide, boscalid, pyrimethanil, kresoxim, kresoxim-methyl, azoxystrobin, difenoconazole, metiram, pyraclostrobin, procymidone, mancozeb, potassium bicarbonate, triflumizole, fluxapyroxad, bixafen, fluindapyr, prothioconazole, propamocarb, fluazinam, copper, copper-based products and salts thereof, captan, folpet, fluopyram, fluoxastrobin, chlorothalonil, sulphur, Bacillus spp., tebuconazole, or combinations thereof.

57. The method of claim 55, wherein the additional agrochemically active agents are alone or collectively applied in a range of 10 g ai/ha to 5000 g ai/ha.

58. The method of claim 55, wherein laminarin is applied in combination with one or more fungicidal treatments jointly, separately, as a premix, tank-mix or in a sequential manner.

59. A combination comprising laminarin and a fungicide selected from cyazofamid, mandipropamide, boscalid, pyrimethanil, kresoxim, kresoxim-methyl, azoxystrobin, difenoconazole, metiram, pyraclostrobin, procymidone, mancozeb, potassium bicarbonate, triflumizole, fluxapyroxad, bixafen, fluindapyr, prothioconazole, propamocarb, fluazinam, copper, copper-based products and salts thereof, captan, folpet, fluopyram, fluoxastrobin, chlorothalonil, sulphur, Bacillus spp., tebuconazole, or combinations thereof.

60. The combination of claim 59, wherein laminarin and the fungicide are combined in a ratio of 1:100 to 100:1.

61. The combination of claim 59, wherein said combination is a pre-mix combination, a tank-mix combination, or a sequential combination.

62. The combination of claim 59, wherein said combination is for improving yield, disease management and post-harvest quality of a crop, a plant or an agricultural produce when contacted with the crop, the plant or the agricultural produce at the pre-harvest stage.

63. The combination of claim 62, wherein said combination is for attaining improvement in yield, disease management and post-harvest quality of a crop, a plant or an agricultural produce is characterized by one or more of following changes in the crop, the plant or the agricultural produce:
i) increase in the yield of the plant, the crop or the agricultural produce;
ii) increased pre-harvest disease management and control of the plant, the crop or the agricultural produce;
iii) increased post-harvest weight, shelf-life and/or vigor of agricultural produce;
iv) decreased post-harvest disease incidence and pest severity;
v) decreased post-harvest degradation and weight losses of agricultural produce; and/or
vi) decreased post-harvest nutrient loss; and/or
vii) increased nutrient content or post-harvest nutrient content.

64. A composition comprising laminarin for improving yield, disease management and post-harvest quality of an agricultural produce, wherein said composition is applied at the pre-harvest stage.

65. The composition of claim 64, wherein the concentration of laminarin in the composition ranges from 10%-80% w/w.

66. The composition of claim 64, wherein the composition further comprises an agriculturally acceptable carrier or vehicle.

67. The composition of claim 64, wherein the composition further comprises one or more additional agrochemically active agents, preferably a fungicide selected from cyazofamid, mandipropamide, boscalid, pyrimethanil, kresoxim, kresoxim-methyl, azoxystrobin, difenoconazole, metiram, pyraclostrobin, procymidone, mancozeb, potassium bicarbonate, triflumizole, fluxapyroxad, bixafen, fluindapyr, prothioconazole, propamocarb, fluazinam, copper, copper-based products and salts thereof, captan, folpet, fluopyram, fluoxastrobin, chlorothalonil, sulphur, Bacillus spp., tebuconazole, or combinations thereof.

68. The composition of claim 64, wherein the composition is applied at a rate of 0.1-20 kg/ha or 0.1-20 l/ha.

69. The method of claim 51, wherein the post-harvest quality is characterized by maintenance of post-harvest vigor of the crop, the plant, or the agricultural produce for at least 7 days after harvest.

70. The method of claim 51, wherein the post-harvest quality is characterized by increased shelf-life of the crop, the plant, or the agricultural produce for at least 20 days after harvest.
